(19) United States
(12) Patent Application Publication
(10) Pub. No.: US 2026/0291064 A1
(43) Pub. Date: Sep. 24, 2026

(54) ELECTRONIC DEVICE

(71) Applicant: GUANGDONG OPPO MOBILE TELECOMMUNICATIONS CORP., LTD., Dongguan (CN)

(72) Inventor: Zhengdong YONG, Dongguan (CN)

(21) Appl. No.: 19/686,785

(22) Filed: May 24, 2026

Related U.S. Application Data
(63) Continuation of application No. PCT/CN2025/077811, filed on Feb. 18, 2025.

(30) Foreign Application Priority Data
Feb. 21, 2024 (CN) 202410196603.7

(51) Int. Cl. H01Q 5/10; H01Q 1/24; H01Q 1/48; H01Q 5/50

(52) U.S. Cl. CPC H01Q 5/10; H01Q 1/48; H01Q 5/50; H01Q 1/243

(57) ABSTRACT

Provided is an electronic device. A radiator is provided on a first side edge of a frame. At least one resonant structure is provided on at least one of a side where a top edge is located, a side where the first side edge is located and a side where a second side edge is located. A direction from a first ground terminal to a first free end of the radiator is the same as or does not intersect with a direction from a second ground terminal to a second free end of the resonant structure. A signal source excites the radiator to operate in a first resonant mode supporting a first frequency band, and excites a reference ground plate to generate a ground plate current. The resonant structure operates in a second resonant mode supporting a second frequency band at least under excitation of the ground plate current.

### CROSS-REFERENCE OF RELATED APPLICATION

This application a continuation of International Patent Application No. PCT/CN2025/077811, filed on Feb. 18, 2025, which claims priority to Chinese Patent Application No. 202410196603.7 filed on Feb. 21, 2024, the entire content of the two applications is incorporated herein by reference.

### TECHNICAL FIELD

The disclosure relates to the field of communication technologies, and particularly to an electronic device.

### BACKGROUND

For a case of designing an antenna on an electronic device to implement satellite communication functions (such as Tiantong satellite communication and Beidou satellite communication), how to achieve good satellite communication of the electronic device has become a technical problem to be solved.

### SUMMARY

Embodiments of the disclosure provide an electronic device.

The electronic device provided by the embodiments of the disclosure includes a reference ground plate, a frame and an antenna assembly. The reference ground plate includes a first ground plate edge, a second ground plate edge, a third ground plate edge and a fourth ground plate edge connected in sequence. The frame surrounds a periphery of the reference ground plate. The frame includes a top edge, a first side edge, a bottom edge and a second side edge which are connected, the top edge being opposite to and spaced apart from the first ground plate edge, the first side edge being opposite to and spaced apart from the second ground plate edge, the bottom edge being opposite to and spaced apart from the third ground plate edge, and the second side edge being opposite to and spaced apart from the fourth ground plate edge. The antenna assembly includes a radiator, a signal source and at least one resonant structure. The radiator is provided on the first side edge, and includes a first ground terminal, a feed point and a first free end arranged in sequence, the first ground terminal being electrically connected to the reference ground plate. The signal source is electrically connected with the feed point, and configured to provide an excitation signal in a satellite communication frequency band. The at least one resonant structure is provided on at least one of a side where the top edge is located, a side where the first side edge is located, and a side where the second side edge is located. The resonant structure includes a second ground terminal and a second free end, the second ground terminal being electrically connected to the reference ground plate. A direction from the first ground terminal to the first free end is the same as or does not intersect with a direction from the second ground terminal to the second free end. The signal source is configured to excite the radiator to operate in a first resonant mode supporting a first frequency band, and excite the reference ground plate to generate a ground plate current. The resonant structure is configured to operate in a second resonant mode supporting a second frequency band at least under excitation of the ground plate current, and a center frequency of the first frequency band is greater than or equal to a center frequency of the second frequency band.

### BRIEF DESCRIPTION OF THE DRAWINGS

To describe the technical solutions of the embodiments of the disclosure more clearly, the accompanying drawings required for the embodiments are briefly introduced below.

FIG. 1 is a schematic structural diagram of an electronic device provided by the embodiments of the disclosure.

FIG. 2 is a partial exploded view of the electronic device provided by the embodiments of the disclosure.

FIG. 3 is a partial schematic diagram of a back cover side of the electronic device provided by the embodiments of the disclosure.

FIG. 4 is a first partial schematic diagram illustrating an antenna assembly and a reference ground plate as provided by the embodiments of the disclosure.

FIG. 5 is a schematic structural diagram illustrating a matching circuit as provided by the embodiments of the disclosure.

FIG. 6 is a second partial schematic diagram illustrating the antenna assembly and the reference ground plate as provided by the embodiments of the disclosure.

FIG. 7 is a schematic structural diagram illustrating a tuning circuit included in the antenna assembly as provided by the embodiments of the disclosure.

FIG. 8 is a schematic structural diagram illustrating the tuning circuit as provided by the embodiments of the disclosure.

FIG. 9 is a schematic structural diagram illustrating a matching circuit and a tuning circuit as provided by the embodiments of the disclosure.

FIG. 10 illustrates a total field pattern of a radiator in the antenna assembly without a resonant structure as provided by the embodiments of the disclosure.

FIG. 11 illustrates a 2D radiation pattern of the radiator in the antenna assembly without a resonant structure as provided by the embodiments of the disclosure.

FIG. 12 illustrates a left-hand circular polarization radiation pattern of the radiator in the antenna assembly without a resonant structure as provided by the embodiments of the disclosure.

FIG. 13 illustrates a total field pattern obtained in a case where a first resonant structure and the radiator are both provided on the first side edge and a second free end of the first resonant structure and the first free end of the radiator both face the top edge, as provided by the embodiments of the disclosure.

FIG. 14 illustrates another total field pattern obtained in the case where the first resonant structure and the radiator are both provided on the first side edge and the second free end of the first resonant structure and the first free end of the radiator both face the top edge, as provided by the embodiments of the disclosure.

FIG. 15 illustrates a left-hand circular polarization radiation pattern obtained in the case where the first resonant structure and the radiator are both provided on the first side edge and the second free end of the first resonant structure and the first free end of the radiator both face the top edge, as provided by the embodiments of the disclosure.

FIG. 16 illustrates a 2D left-hand circular polarization radiation pattern obtained in the case where the first resonant structure and the radiator are both provided on the first side edge and the second free end of the first resonant structure and the first free end of the radiator both face the top edge, as provided by the embodiments of the disclosure.

FIG. 17 illustrates a total field pattern obtained in a case where the first resonant structure and the radiator are both provided on the first side edge and the second free end of the first resonant structure and the first free end of the radiator both face the bottom edge, as provided by the embodiments of the disclosure.

FIG. 18 illustrates a 2D radiation pattern obtained in the case where the first resonant structure and the radiator are both provided on the first side edge and the second free end of the first resonant structure and the first free end of the radiator both face the bottom edge, as provided by the embodiments of the disclosure.

FIG. 19 is a schematic structural diagram in which the first resonant structure and the radiator are provided on a same side of a rotating shaft, as provided by the embodiments of the disclosure.

FIG. 20 illustrates a total field radiation pattern of the antenna assembly without a resonant structure in a foldable device as provided by the embodiments of the disclosure.

FIG. 21 illustrates a first total field radiation pattern obtained in a case where the first resonant structure and the radiator are provided on the same side of the rotating shaft in the foldable device as provided by the embodiments of the disclosure.

FIG. 22 illustrates a second total field radiation pattern obtained in the case where the first resonant structure and the radiator are provided on the same side of the rotating shaft in the foldable device as provided by the embodiments of the disclosure.

FIG. 23 illustrates a third total field radiation pattern of the antenna assembly without a resonant structure in the foldable device as provided by the embodiments of the disclosure.

FIG. 24 illustrates a left-hand circular polarization radiation pattern of the antenna assembly without a resonant structure in the foldable device as provided by the embodiments of the disclosure.

FIG. 25 illustrates a fourth total field radiation pattern obtained in the case where the first resonant structure and the radiator are provided on the same side of the rotating shaft in the foldable device as provided by the embodiments of the disclosure.

FIG. 26 illustrates a left-hand circular polarization field radiation pattern obtained in the case where the first resonant structure and the radiator are provided on the same side of the rotating shaft in the foldable device as provided by the embodiments of the disclosure.

FIG. 27 illustrates a total field radiation pattern obtained when the antenna assembly without a resonant structure in the foldable device is close to head, as provided by the embodiments of the disclosure.

FIG. 28 illustrates a total field radiation pattern obtained in the case where the first resonant structure and the radiator are provided on the same side of the rotating shaft in the foldable device as provided by the embodiments of the disclosure.

FIG. 29 is a schematic structural diagram in which a resonant structure is provided on the top edge as provided by the embodiments of the disclosure.

FIG. 30 illustrates a total field pattern of a second resonant structure and the radiator as provided by the embodiments of the disclosure.

FIG. 31 illustrates a 3D left-hand circular polarization radiation pattern of the second resonant structure and the radiator as provided by the embodiments of the disclosure.

FIG. 32 illustrates a 2D left-hand circular polarization radiation pattern of the second resonant structure and the radiator as provided by the embodiments of the disclosure.

FIG. 33 is a schematic current distribution diagram of the radiator in the antenna assembly without a resonant structure and the reference ground plate as provided by the embodiments of the disclosure.

FIG. 34 is a schematic current distribution diagram of the second resonant structure, the radiator and the reference ground plate as provided by the embodiments of the disclosure.

FIG. 35 illustrates an upper hemisphere radiation ratio of the antenna assembly without a resonant structure as provided by the embodiments of the disclosure.

FIG. 36 illustrates an upper hemisphere radiation ratio of an antenna assembly in which the second resonant structure located on the top edge and the radiator form an antenna pair as provided by the embodiments of the disclosure.

FIG. 37 is a schematic structural diagram in which an antenna assembly includes both the first resonant structure and the second resonant structure as provided by the embodiments of the disclosure.

FIG. 38 illustrates a total field pattern of the first resonant structure, the second resonant structure and the radiator as provided by the embodiments of the disclosure.

FIG. 39 illustrates a 3D left-hand circular polarization radiation pattern of the first resonant structure, the second resonant structure and the radiator as provided by the embodiments of the disclosure.

FIG. 40 illustrates a 2D left-hand circular polarization radiation pattern of the first resonant structure, the second resonant structure and the radiator as provided by the embodiments of the disclosure.

FIG. 41 is a schematic current distribution diagram of the first resonant structure, the second resonant structure, the radiator and the reference ground plate as provided by the embodiments of the disclosure.

FIG. 42 illustrates an upper hemisphere radiation ratio of an antenna assembly in which the first resonant structure, the second resonant structure and the radiator form an antenna cluster as provided by the embodiments of the disclosure.

FIG. 43 is a schematic structural diagram in which a resonant structure is provided on the second side edge as provided by the embodiments of the disclosure.

FIG. 44 is a schematic structural diagram in which a direction from the second ground terminal to the second free end of a third resonant structure is the same as a direction from the first ground terminal to the first free end of the radiator as provided by the embodiments of the disclosure.

FIG. 45 is a partial schematic diagram of an antenna assembly provided on a foldable device as provided by the embodiments of the disclosure.

FIG. 46 illustrates a total field pattern obtained in a case where the first resonant structure, the second resonant structure and the radiator are provided on the same side of the rotating shaft in the foldable device as provided by the embodiments of the disclosure.

FIG. 47 illustrates a 3D left-hand circular polarization radiation pattern obtained in the case where the first resonant structure, the second resonant structure and the radiator are provided on the same side of the rotating shaft in the foldable device as provided by the embodiments of the disclosure.

FIG. 48 illustrates a 2D left-hand circular polarization radiation pattern obtained in a case where the first resonant structure, the second resonant structure and the radiator are provided on the same side of the rotating shaft in the foldable device as provided by the embodiments of the disclosure.

FIG. 49 is a schematic current distribution diagram obtained in the case where the first resonant structure, the second resonant structure and the radiator are provided on the same side of the rotating shaft in the foldable device as provided by the embodiments of the disclosure.

FIG. 50 illustrates an upper hemisphere radiation ratio obtained in the case where the first resonant structure, the second resonant structure and the radiator are provided on the same side of the rotating shaft in the foldable device as provided by the embodiments of the disclosure.

FIG. 51 is a schematic structural diagram of another antenna assembly provided on a foldable device as provided by the embodiments of the disclosure.

FIG. 52 is a schematic structural diagram illustrating a second type of first resonant structure as provided by the embodiments of the disclosure.

FIG. 53 is a schematic structural diagram of the antenna assembly further including a second signal source and a first switch unit as provided by the embodiments of the disclosure.

FIG. 54 is a schematic structural diagram of an antenna assembly further including a third signal source and a second switch unit as provided by the embodiments of the disclosure.

FIG. 55 is a schematic structural diagram of an antenna assembly further including a fourth signal source and a third switch unit as provided by the embodiments of the disclosure.

FIG. 56 is a schematic structural diagram of an antenna assembly further including a fifth signal source and a fourth switch unit as provided by the embodiments of the disclosure.

### DETAILED DESCRIPTION OF PREFERRED EMBODIMENTS

The technical solutions of the disclosure will be clearly and comprehensively described below with reference to the accompanying drawings. Apparently, the embodiments described in the disclosure are only a part of the embodiments, but not all of the embodiments. All other embodiments obtained by those of ordinary skill in the art without creative efforts based on the embodiments provided by the disclosure shall fall within the protection scope of the disclosure.

Reference to “an embodiment” throughout the disclosure means that a particular feature, structure, or characteristic described in connection with the embodiment may be included in at least one embodiment of the disclosure. The appearances of the phrase in various positions of the specification are not necessarily all refer to a same embodiment, nor are separate or alternative embodiments mutually exclusive of other embodiments. It is explicitly and implicitly understood by those skilled in the art that the embodiments described in the disclosure may be combined with other embodiments.

Terms “first”, “second” and the like in the specification and claims of the disclosure and the above accompanying drawings are used to distinguish different objects, rather than to describe a specific order. In addition, terms “comprise/include” and “have” as well as any variations thereof are intended to cover non-exclusive inclusion. For example, a component or device including one or more elements is not limited to the listed one or more elements, and optionally further includes other elements not listed but inherent to the product, or other elements that should be included for the functions described.

Referring to FIG. 1, a schematic structural diagram of an electronic device 1000 provided by the embodiments of the disclosure is illustrated. The electronic device 1000 includes, but is not limited to, a mobile phone, a tablet computer, a laptop computer, a computer, a wearable device, an unmanned aerial vehicle, a robot, a digital camera and other devices with communication functions. The embodiments of the disclosure are described by taking a mobile phone as an example, and other electronic devices may refer to these embodiments.

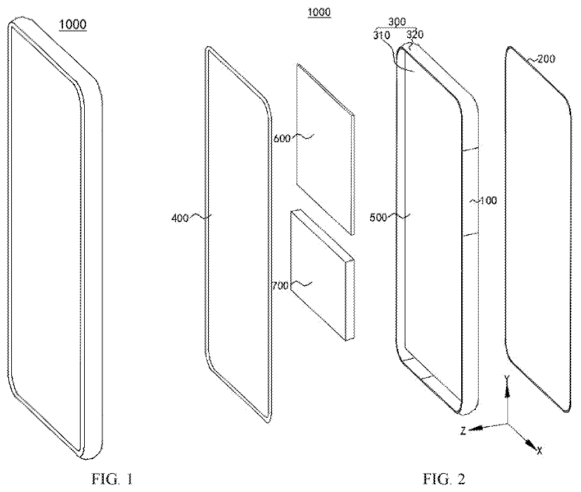

Referring to FIG. 2, a partial exploded view of the electronic device 1000 is illustrated. The electronic device 1000 includes an antenna assembly 100. The working environment of the antenna assembly 100 is illustrated by taking the electronic device 1000 as a mobile phone as an example. The electronic device 1000 includes a display screen 200, a middle frame 300 and a back cover 400 arranged in sequence along a thickness direction. The middle frame 300 includes a middle plate 310 and a frame 320 surrounding the periphery of the middle plate 310. The frame 320 may be an electrically conductive frame. Certainly, in some other embodiments, the electronic device 1000 may not have the middle plate 310. The display screen 200, the middle plate 310 and the back cover 400 are stacked in sequence, and accommodating spaces are defined between the display screen 200 and the middle plate 310 and between the middle plate 310 and the back cover 400, to accommodate components such as a main board, a camera module, a receiver module, a battery and various sensors. One side of the frame 320 surrounds an edge of the display screen 200, and the other side of the frame 320 surrounds an edge of the back cover 400, so that a complete appearance structure of the electronic device 1000 is provided. In this embodiment, the frame 320 and the middle plate 310 are an integrated structure, and the frame 320 and the back cover 400 may be discrete structures. The above illustrates the working environment of the antenna assembly 100 by taking a mobile phone as an example, but the antenna assembly 100 of the disclosure is not limited to the above working environment.

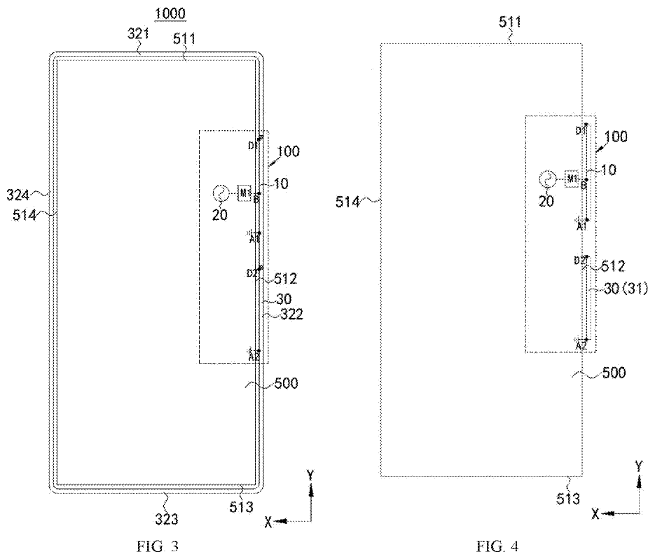

Referring to FIG. 3, a back view of the electronic device 1000 is illustrated. The frame 320 includes a top edge 321 and a bottom edge 323 opposite to each other, and includes a first side edge 322 and a second side edge 324 each being connected between the top edge 321 and the bottom edge 323. The top edge 321 is an edge away from the ground when a user holds the electronic device 1000 and uses it in portrait mode, and the bottom edge 323 is an edge facing the ground when the user holds the electronic device 1000 and uses it in portrait mode. The first side edge 322 is a left side edge when the user holds the electronic device 1000 and uses it in portrait mode. The second side edge 324 is a right side edge when the user holds the electronic device 1000 and uses it in portrait mode. Certainly, the first side edge 322 may also be a right side edge when the user holds the electronic device 1000 and uses it in portrait mode, and the second side edge 324 is a left side edge when the user holds the electronic device 1000 and uses it in portrait mode.

In some implementations, referring to FIG. 3, the electronic device 1000 further includes a reference ground plate (ground plane) 500. The reference ground plate 500 is provided within the frame 320. The reference ground plate 500 is substantially rectangular. Various slots and holes are provided on the ground plate edges of the reference ground plate 500, since some components needs to be arranged or other structures need to be avoided in the mobile phone. The reference ground plate 500 includes, but is not limited to, a metal alloy part of the middle plate 310 and a reference ground metal part of a circuit board (including a main board 600 and a sub-board). Generally, the reference ground system in the electronic device 1000 may be equivalent to being substantially rectangular in shape, so it is called the reference ground plate 500. The reference ground plate 500 does not indicate that the reference ground is plate-shaped and it is a rectangular plate.

Referring to FIG. 3, the reference ground plate 500 includes a first ground plate edge 511, a second ground plate edge 512, a third ground plate edge 513 and a fourth ground plate edge 514 connected in sequence. The first ground plate edge 511 is opposite to and spaced apart from the top edge 321, and the second ground plate edge 512 is opposite to and spaced apart from the first side edge 322. The third ground plate edge 513 is opposite to and spaced apart from the bottom edge 323, and the fourth ground plate edge 514 is opposite to and spaced apart from the second side edge 324.

In some implementations, the length of the first ground plate edge 511 is similar to or equal to the length of the third ground plate edge 513. The length of the second ground plate edge 512 is similar to or equal to the length of the fourth ground plate edge 514. The first ground plate edge 511 and the third ground plate edge 513 are short edges of the reference ground plate 500. The second ground plate edge 512 and the fourth ground plate edge 514 are long edges of the reference ground plate 500.

The specific structure of the antenna assembly 100 is illustrated below with reference to the accompanying drawings.

Referring to FIG. 3 and FIG. 4, the antenna assembly 100 includes a radiator 10, a first signal source 20 and at least one resonant structure 30.

The material of the radiator 10 is not specifically limited in the disclosure. In some implementations, the material of the radiator 10 is an electrically conductive material, including but not limited to metal, alloy and other electrically conductive materials. The shape of the radiator 10 is not specifically limited in the disclosure. For example, the radiator 10 is strip-shaped, sheet-shaped or rod-shaped, or in form of a coating or a film, but it is not limited thereto. The radiator 10 illustrated in FIG. 3 is only an example, and it does not limit the shape of the radiator 10 provided by the disclosure. In this embodiment, the radiator 10 is strip-shaped. The extension trajectory of the radiator 10 is not limited in the disclosure. In some implementations, the radiator 10 may extend along a straight line, a curved line or a polyline. The radiator 10 may be a line with a uniform width along the extension trajectory, or a strip with a non-uniform width such as a strip with a gradually changing width or a strip provided with a widened area.

The form of the radiator 10 is not specifically limited in the disclosure. In some implementations, the radiator 10 is a metal frame 320, a metal frame embedded in a plastic frame 320, a metal radiator 10 located in or on a surface of the frame 320, a flexible printed circuit (FPC) antenna formed on a flexible printed circuit board, a laser direct structuring (LDS) antenna, a print direct structuring (PDS) antenna, a conductive sheet antenna (such as a metal bracket antenna) and the like, but it is not limited thereto. In the embodiments, the radiator 10 is taken as a part of the metal frame 320 of the electronic device 1000 as an example. The specific position of the radiator 10 provided on the frame 320 is not limited in the disclosure.

Referring to FIG. 3 and FIG. 4, the radiator 10 is provided on the first side edge 322. The radiator 10 is arranged along the second ground plate edge 512, and spaced apart from the second ground plate edge 512.

A head-hand satellite call mode is a call mode in which an operator holds, with his/her hand, the electronic device 1000 near the head. In this mode, since an antenna located on the top edge 321 is close to the head, it is easily affected by head (top) dielectric loading to cause detuning (frequency offset), serious efficiency reduction or failure to transmit and receive satellite signals. The radiator 10 placed on the first side edge 322 as provided in the embodiments of the disclosure is relatively far away from the head, for example, the distance of the radiator from the center of the head is greater than 5 cm, and the head dielectric loading has little or no influence on the radiator 10 located on the first side edge 322, so that the antenna assembly 100 provided by the embodiments of the disclosure can work normally in the head-hand satellite call mode.

In addition, the antenna located on the top edge 321 is close to the human head in the head-hand satellite call mode, which causes a risk of excessive specific absorption rate (SAR). The radiator 10 provided by the embodiments of the disclosure is located at a position relatively far away from the human head, reducing the risk of excessive SAR.

Referring to FIG. 3 and FIG. 4, the radiator 10 includes a first ground terminal A1, a feed point B and a first free end D1 arranged in sequence. The first ground terminal A1 is electrically connected to the reference ground plate 500.

The free end in the disclosure refers to an end that is disconnected from other electrically conductive parts of the frame 320 through an insulating gap and is not electrically connected to the reference ground plate 500. An insulating material is filled in the insulating gap, to ensure the structural strength of the frame 320 of the electronic device 1000.

The first ground terminal A1 is electrically connected to the reference ground plate 500. The first ground terminal A1 in the disclosure is a position electrically connected to the reference ground plate 500. The electrical connection includes, but is not limited to, direct electrical connection or indirect electrical connection. For example, the first ground terminal A1 is grounded through a ground elastic piece. For another example, the first ground terminal A1 of the radiator 10 is interconnected with a part of the reference ground plate 500 to form an integral piece, that is, it is physically grounded.

A direction from the first ground terminal A1 to the first free end D1 is the same as or does not intersect with a direction from a second ground terminal A2 to a second free end D2.

For example, when the resonant structure 30 is provided on the side where the first side edge 322 is located or a side where the second side edge 324 is located, the direction from the first ground terminal A1 to the first free end D1 is the same as the direction from the second ground terminal A2 to the second free end D2. For example, both the direction from the first ground terminal A1 to the first free end D1 and the direction from the second ground terminal A2 to the second free end D2 point to the top edge 321, or both the direction from the first ground terminal A1 to the first free end D1 and the direction from the second ground terminal A2 to the second free end D2 point to the bottom edge 323.

For another example, when the resonant structure 30 is provided on a side where the top edge 321 is located, the direction from the first ground terminal A1 to the first free end D1 does not intersect with the direction from the second ground terminal A2 to the second free end D2. Further, the first side edge 322 is the right side edge of the frame 320 in the back view thereof. In this case, the direction from the first ground terminal A1 to the first free end D1 is an upward direction along the first side edge 322. The direction from the second ground terminal A2 to the second free end D2 is a leftward direction along the top edge 321. The resonant structure 30 is located on the left side of a straight line where the radiator 10 is located, and the free end of the resonant structure 30 faces left. In this case, the direction from the first ground terminal A1 to the first free end D1 does not intersect with the direction from the second ground terminal A2 to the second free end D2. In this embodiment, the second ground terminal A2 is located at a side close to the first side edge 322, so as to enhance the coupling effect between the radiator 10 and the resonant structure 30.

It is notable that, for a case where both the radiator 10 and the resonant structure 30 are provided on the first side edge 322, the direction from the first ground terminal A1 to the first free end D1 is an upward direction, and the direction from the second ground terminal A2 to the second free end D2 is a downward direction, it means a case where the direction from the first ground terminal A1 to the first free end D1 is opposite to and overlaps with the direction from the second ground terminal A2 to the second free end D2, and this case does not belong to the case where the direction from the first ground terminal A1 to the first free end D1 does not intersect with the direction from the second ground terminal A2 to the second free end D2.

The first signal source 20 is electrically connected with the feed point B. The first signal source 20 is configured to provide an excitation signal in a satellite communication frequency band.

Referring to FIG. 3 and FIG. 4, the first signal source 20 is electrically connected with the feed point B. The first signal source 20 includes, but is not limited to, a radio frequency transceiver chip and the like. In the embodiments of the disclosure, the first signal source 20 is provided on the main board 600. The electrical connection between the first signal source 20 and the feed point B includes, but is not limited to, an indirect connection implemented through for example a coaxial line and an electrically conductive elastic piece. Specifically, the first signal source 20 is electrically connected with the feed point B through a feed elastic piece (electrically conductive elastic piece/spring) provided on the main board 600.

Referring to FIG. 3 and FIG. 4, the antenna assembly 100 further includes a matching circuit M1. The matching circuit M1 is electrically connected between the first signal source 20 and the feed point B. The matching circuit M1 and the first signal source 20 may be connected through a coaxial line, and the matching circuit M1 and the feed point B are electrically connected through a feed elastic piece (electrically conductive elastic piece/spring). The matching circuit M1 includes at least one of a capacitor and an inductor. The matching circuit M1 adjusts the impedance matching between the first signal source 20 and the radiator 10, facilitating excitation of a resonant mode of the radiator 10.

Further, referring to FIG. 5, the matching circuit M1 may further include a matching switch M12 and multiple matching branches M11 electrically connected with the matching switch. The matching switch M12 switches different matching branches M11, to realize switching of the frequency band (first frequency band) supported by the radiator 10 or realize impedance matching when the radiator 10 is switched to support a different signal (in Tiantong satellite frequency band or mobile communication frequency band).

The resonant structure 30 is provided on at least one of the side where the top edge 321 is located, the side where the first side edge 322 is located, and the side where the second side edge 324 is located.

For example, when there is one resonant structure 30, the one resonant structure 30 may be provided on the side where the top edge 321 is located, the side where the first side edge 322 is located, or the side where the second side edge 324 is located.

For example, when there are two resonant structures 30, the two resonant structures 30 may be provided on any two of the side where the top edge 321 is located, the side where the first side edge 322 is located, and the side where the second side edge 324 is located.

For example, when there are three resonant structures 30, the resonant structures 30 may be provided on all three of the side where the top edge 321 is located, the side where the first side edge 322 is located, and the side where the second side edge 324 is located.

In some implementations, the resonant structure 30 may be a part of the frame or a part of the reference ground plate 500.

Referring to FIG. 3 and FIG. 4, the resonant structure 30 includes a second ground terminal A2 and a second free end D2. The second ground terminal A2 is electrically connected to the reference ground plate 500.

The first signal source 20 is configured to excite the radiator 10 to operate in a first resonant mode supporting a first frequency band, and excite the reference ground plate 500 to generate a ground plate current. The resonant structure 30 operates in a second resonant mode supporting a second frequency band, at least under excitation of the ground plate current. The center frequency of the first frequency band is greater than or equal to the center frequency of the second frequency band.

The first signal source 20 is configured to excite the radiator 10 to operate in the first resonant mode supporting the first frequency band, and excite the reference ground plate 500 to generate the ground plate current.

The resonant structure 30 operates in the second resonant mode supporting the second frequency band, at least under excitation of the ground plate current. The center frequency of the first frequency band is greater than or equal to the center frequency of the second frequency band.

Specifically, the first signal source 20 provides an excitation signal in the satellite communication frequency band, to excite the radiator 10 to generate a first resonant current, and excite the reference ground plate 500 to generate the ground plate current. And in this case, when the electrical length of the resonant structure 30 meets the resonance condition, the resonant structure 30 guides the ground plate current to concentrate on the resonant structure 30, and operates at the second resonant mode supporting the second frequency band. In some implementations, the first frequency band covers the satellite communication frequency band, and the first resonant mode is a principal radiation mode, so that the antenna assembly 100 supports the satellite communication frequency band, enabling satellite calls of the electronic device.

The second resonant mode of the resonant structure 30 is an auxiliary radiation mode. In one aspect, the resonant structure 30 tunes the radiation pattern of the antenna assembly 100 by changing the current distribution of the reference ground plate 500. In another aspect, when the resonance point of the second resonant mode of the resonant structure 30 is equal to the resonance point of the first resonant mode, a wide frequency band is provided together with the first resonant mode, and the energy radiation of the antenna assembly 100 in the satellite frequency band is enhanced. In a third aspect, when the resonance point of the second resonant mode of the resonant structure 30 is smaller than the resonance point of the first resonant mode, the resonance efficiency of the first resonant mode can be improved.

In some implementations, the resonance point of the second resonant mode (the center frequency of the second frequency band) is slightly smaller than the resonance point of the first resonant mode (the center frequency of the first frequency band). The specific resonance point of the second resonant mode is not specifically limited in the disclosure, and it is mainly based on that the second resonant mode of the resonant structure 30 enables the upper hemisphere energy ratio of the antenna assembly 100 to be greater than or equal to a preset upper hemisphere energy ratio. The preset upper hemisphere energy ratio is an upper hemisphere energy ratio when the resonant structure 30 is not provided, for example, 40%. For example, the resonance point of the first resonant mode is 2.0 GHZ, and the resonance point of the second resonant mode is 1.9 GHZ. In this case, the upper hemisphere energy ratio of the antenna assembly 100 during operation is 70%, and it is considered that the resonance point of the second resonant mode may include 1.9 GHZ. For another example, the resonance point of the first resonant mode is 2.0 GHZ, and the resonance point of the second resonant mode is 1.2 GHz. In this case, the upper hemisphere energy ratio of the antenna assembly 100 during operation is 39%, and it is considered that 1.2 GHz is not suitable as the resonance point of the second resonant mode.

In the electronic device 1000 provided by the embodiments of the disclosure, the radiator 10 is provided on the first side edge 322 of the frame, the radiator 10 includes the first ground terminal A1, the feed point B and the first free end D1 arranged in sequence, and the first ground terminal A1 is electrically connected to the reference ground plate 500. The first signal source 20 is electrically connected with the feed point B, and the first signal source 20 is configured to provide the excitation signal in the satellite communication frequency band. The resonant structure 30 is provided on at least one of the side where the top edge 321 is located, the side where the first side edge 322 is located, and the side where the second side edge 324 is located, the resonant structure 30 includes the second ground terminal A2 and the second free end D2, and the second ground terminal A2 is electrically connected to the reference ground plate 500. The direction from the first ground terminal A1 to the first free end D1 is the same as or does not intersect with the direction from the second ground terminal A2 to the second free end D2. The first signal source 20 is configured to excite the radiator 10 to operate in the first resonant mode supporting the first frequency band, and excite the reference ground plate 500 to generate the ground plate current. The resonant structure 30 operates in the second resonant mode supporting the second frequency band at least under excitation of the ground plate current, and the center frequency of the first frequency band is greater than or equal to the center frequency of the second frequency band. Through the above design, resonance of the radiator 10 and the resonant structure 30 is enabled, in which the resonant structure 30 is used to change the current distribution on the reference ground plate 500, thereby tuning the radiation pattern of the antenna assembly 100 and achieving good satellite communication.

The following embodiments of the disclosure are described by taking, as an example, a case where both the first frequency band supported by the first resonant mode and the second frequency band supported by the second resonant mode cover the satellite communication frequency band.

In some implementations, in the embodiments of the disclosure, by providing the resonant structure 30 on the side where the first side edge 322 is located, the side where the top edge 321 is located, or the side where the second side edge 324 is located, the resonant structure 30 can guide the ground plate current on the reference ground plate 500 to be more concentrated near the resonant structure 30, and thus tune the radiation pattern of the antenna assembly 100 by changing the current distribution on the reference ground plate 500, thereby improving the upper hemisphere energy ratio and achieving good satellite communication of the electronic device.

In some implementations, when there is one resonant structure 30, the one resonant structure 30 and the radiator 10 may form an antenna pair. When there are multiple resonant structures 30, the multiple resonant structures 30 and the radiator 10 may form an antenna cluster.

Further, the principal radiation patterns of the antenna assembly 100 in the first resonant mode and the second resonant mode point to the side where the top edge 321 is located. Generally, the electronic device 1000 is used in a state where the top edge 321 points to the air. By directing the principal radiation pattern of the antenna assembly 100 to the side where the top edge 321 is located, direct communication between the electronic device 1000 and a satellite equipment can be facilitated.

In some implementations, the resonant structure 30 is provided on the side where the top edge 321 is located, and the resonant structure 30 is configured to guide the ground plate current on the reference ground plate 500 to an area close to the top edge 321. In this way, the longitudinal current intensity of the upper half of the reference ground plate 500 is enhanced, the contribution of the longitudinal ground plate current of the upper half of the reference ground plate 500 to the radiation of the antenna assembly 100 is improved, and the radiation pattern of the antenna assembly 100 points to the side where the top edge 321 is located, thereby improving the upper hemisphere energy ratio of the antenna assembly 100 in the satellite communication frequency band. The longitudinal direction is a direction parallel to the second ground plate edge.

In some implementations, the resonant structure 30 is provided on the side where the first side edge 322 is located, the resonant structure 30 and the radiator 10 form an antenna pair, and the phase relationship between the resonant structure 30 and the radiator 10 is designed, so that the radiation pattern of the antenna assembly 100 points to the side where the top edge 321 is located, thereby improving the upper hemisphere energy ratio of the antenna assembly 100 in the satellite communication frequency band.

In some implementations, the resonant structure 30 is provided on the side where the second side edge 324 is located, and the resonant structure 30 is configured to guide the ground plate current on the reference ground plate 500 to an area close to the second side edge 324. In this way, the transverse current intensity of the reference ground plate 500 is enhanced, and the radiation pattern of the antenna assembly 100 is caused to point to the side where the top edge 321 is located, thereby improving the upper hemisphere energy ratio of the antenna assembly 100 in the satellite communication frequency band. The transverse direction is a direction parallel to the first ground plate edge 511.

The following illustrates the improvement of the upper hemisphere energy ratio of the antenna assembly 100 by providing the resonant structure 30 in the disclosure with reference to the accompanying drawings.

In some implementations, referring to FIG. 4, the at least one resonant structure 30 includes a first resonant structure 31. The first resonant structure 31 is provided on the side where the first side edge 322 is located. The direction from the second ground terminal A2 to the second free end D2 of the first resonant structure 31 is the same as the direction from the first ground terminal A1 to the first free end D1 of the radiator 10.

In other words, the first resonant structure 31 and the radiator 10 are provided on a same side of the reference ground plate 500, for example, both are provided on the first side edge 322. Further, the free end of the first resonant structure 31 faces the same direction as the free end of the radiator 10.

Specifically, referring to FIG. 4, both the free end of the first resonant structure 31 and the free end of the radiator 10 face the side where the top edge 321 is located.

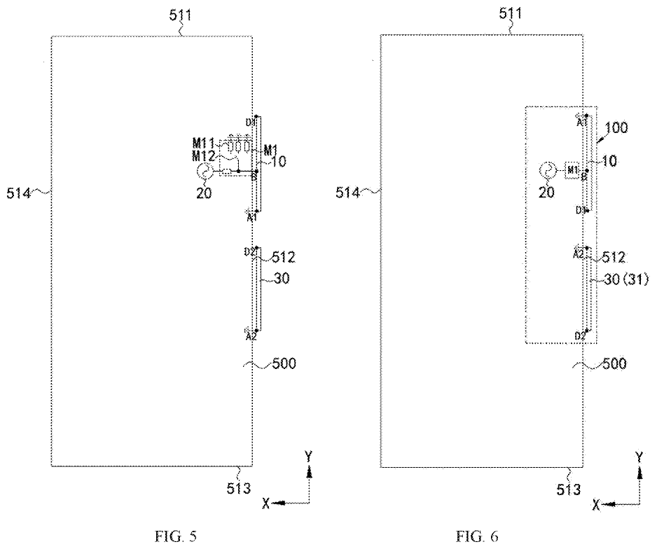

Referring to FIG. 6, both the free end of the first resonant structure 31 and the free end of the radiator 10 face the side where the bottom edge 323 is located. If the free end of the first resonant structure 31 faces an opposite direction to the free end of the radiator 10, common mode and differential mode are generated, and a good radiation pattern pointing to the top edge 321 cannot be provided. By designing the free end of the first resonant structure 31 to face the same direction as the free end of the radiator 10, a good pattern radiation pattern pointing to the top edge 321 is facilitated.

The first resonant mode is a quarter-wavelength mode resonating between the first ground terminal A1 and the first free end D1 and supporting the first frequency band. In other words, the main resonant current of the first resonant mode is distributed between the first ground terminal A1 and the first free end D1, that is, on the entire branch of the radiator 10. The electrical length of the radiator 10 is close to or equal to a quarter wavelength at the center frequency of the first frequency band, so as to excite the quarter-wavelength mode supporting the first frequency band between the first ground terminal A1 and the first free end D1.

The current distribution of the main resonant current of the first resonant mode includes that the current flows from the first ground terminal A1 to the first free end D1. Due to the periodicity of the current, at other times, the current may also flow from the first free end D1 to the first ground terminal A1.

The electrical length in the embodiments of the disclosure may satisfy the following formula:

$$\overline{L} = L \times \frac{a}{b}$$

where L represents the physical length, a represents the transmission time of an electrical or electromagnetic signal in a medium, and b represents the transmission time in a free scene.

As mentioned above, the radiator 10 is an IFA antenna. The first resonant mode is close to or equal to a quarter-wavelength mode at the first frequency band. The quarter-wavelength mode is the fundamental mode of the IFA antenna, with relatively high efficiency, so as to ensure that the first frequency band supported by the first resonant mode has relatively high efficiency.

The second resonant mode is a quarter-wavelength mode resonating between the second ground terminal A2 and the second free end D2 and supporting the second frequency band. In other words, the main resonant current of the second resonant mode is distributed between the second ground terminal A2 and the second free end D2, that is, on the entire branch of the resonant structure 30. The electrical length of the resonant structure 30 is close to or equal to a quarter wavelength at the center frequency of the second frequency band, so as to excite the quarter-wavelength mode supporting the second frequency band between the second ground terminal A2 and the second free end D2.

The current distribution of the main resonant current of the second resonant mode includes that the current flows from the second ground terminal A2 to the second free end D2. Due to the periodicity of the current, at other times, the current may also flow from the second free end D2 to the second ground terminal A2.

In some implementations, both the first frequency band and the second frequency band cover the Tiantong satellite communication frequency band (1980 MHz-2200 MHz), or a continuous frequency band formed by the first frequency band and the second frequency band covers the Tiantong satellite communication frequency band (1980 MHz-2200 MHz).

Referring to FIG. 4 and FIG. 6, the first resonant structure 31 and the radiator 10 form an antenna pair.

Further, referring to FIG. 4 and FIG. 6, the first resonant structure 31 is located on a side of the radiator 10 away from the top edge 321. By designing the radiator 10 to be located between the first resonant structure 31 and the top edge 321, the phase of the first resonant current of the radiator 10 in the first resonant mode lags behind the phase of the second resonant current of the first resonant structure 31 in the second resonant mode, and the radiation direction is from a part leading in phase to a part lagging in phase. In this way, the radiation direction of the antenna assembly 100 is from the first resonant structure 31 to the radiator 10, that is, the radiation direction of the antenna assembly 100 points toward the top edge 321.

In some implementations, the first resonant structure 31 and the radiator 10 are provided on the same side. In one aspect, the first resonant structure 31 and the radiator 10 are coupled through the ground plate current on the reference ground plate 500. That is, the first signal source 20 excites a first resonant current on the radiator 10 and a ground plate current on the reference ground plate 500, and when the electrical length of the first resonant structure 31 meets a resonance condition, more ground plate current is attracted, and a second resonant current is produced on the first resonant structure 31. In addition, the first ground terminal A1 is a strong magnetic field position, the second free end D2 is a strong electric field position, and there is a coupling gap between the first ground terminal A1 and the second free end D2. Alternatively, the first free end D1 is a strong electric field position, the second ground terminal A2 is a strong magnetic field position, and there is a coupling gap between the second ground terminal A2 and the first free end D1. The radiator 10 and the first resonant structure 31 form a magnetic field-electric field coupling structure, that is, space coupling is also enabled between the radiator 10 and the first resonant structure 31.

The coupling effect between the radiator 10 and the first resonant structure 31 affects the current phase difference between the radiator 10 and the first resonant structure 31. Thus, by designing the coupling strength between the radiator 10 and the first resonant structure 31, the current phase difference between the first resonant structure 31 and the radiator 10 can be tuned. In addition, the current phase difference between the first resonant structure 31 and the radiator 10 is tuned by tuning the center frequency of the first frequency band and the center frequency of the second frequency band.

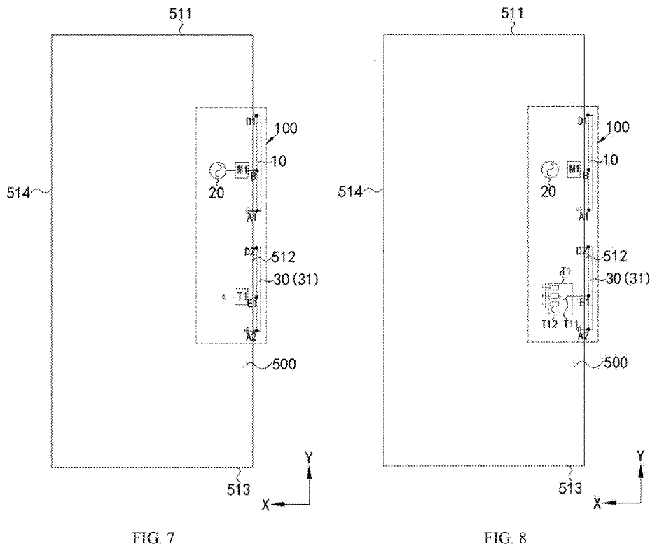

In some implementations, referring to FIG. 7, the radiator 10 includes a first connection point E1. The first connection point E1 is located between the second ground terminal A2 and the second free end D2, or located at the second ground terminal A2.

In some implementations, referring to FIG. 7, the antenna assembly 100 includes a tuning circuit T1. One terminal of the tuning circuit T1 is electrically connected with the first connection point E1, and the other terminal of the tuning circuit T1 is grounded. The tuning circuit T1 is configured to tune the resonance frequency of the resonant structure 30, that is, tune the center frequency of the second frequency band.

The tuning circuit T1 includes, but is not limited to, components such as an inductor and a capacitor.

Further, referring to FIG. 8, the tuning circuit T1 further includes a tuning switch T11 and multiple tuning branches T12. One terminal of the tuning switch T11 is electrically connected to the first connection point E1, one terminal of each of the multiple tuning branches T12 is capable of being electrically connected with the other terminal of the tuning switch T11, and the other terminals of the multiple tuning branches T12 are grounded.

The individual tuning branches T12 have different impedance values. For example, the multiple tuning branches T12 are multiple capacitors with different capacitances; or the multiple tuning branches T12 are multiple inductors with different inductances; or the multiple tuning branches T12 include multiple capacitors with different capacitances and multiple inductors with different inductances. By adjusting the tuning switch T11 to be electrically connected to different components, the equivalent electrical length electrically connected to the radiator 10 and the equivalent electrical length of the tuning branch T12 are adjusted, thereby switching the resonance point of the second resonant mode.

In some implementations, the tuning branch T12 includes an adjustable capacitor.

When the tuning circuit T1 is provided, the equivalent electrical length formed by the branch between the second ground terminal A2 and the second free end D2 of the first resonant structure 31 and the tuning circuit T1 is close to a quarter wavelength at the resonance point of the second resonant mode.

In some other embodiments, the resonant structure 30 may not include the tuning circuit T1, and the electrical length between the second ground terminal A2 and the second free end D2 of the resonant structure 30 has met the resonance condition for generating resonance on the resonant structure 30 (for example, the electrical length is close to a quarter wavelength at the second frequency band).

The structure of the matching circuit M1 is not specifically limited in the disclosure.

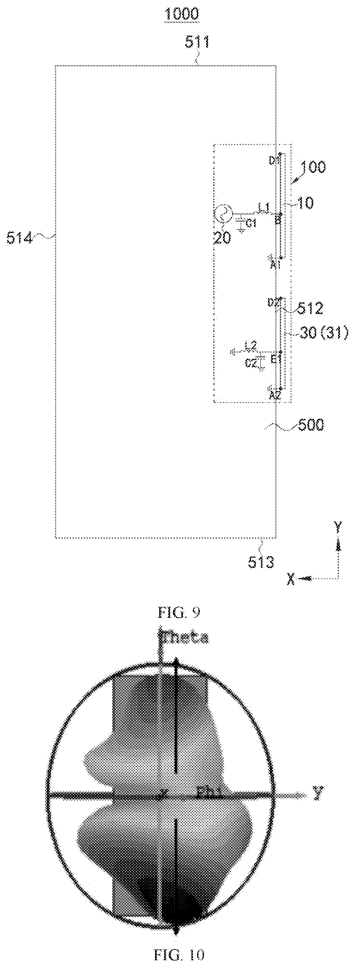

For example, referring to FIG. 9, the matching circuit M1 includes a first inductor L1 and a first capacitor C1. The first inductor L1 is electrically connected between the feed point B and the first signal source 20. One terminal of the first capacitor C1 is electrically connected between the first inductor L1 and the first signal source 20, and the other terminal of the first capacitor C1 is grounded. The inductance of the first inductor L1 and the capacitance of the first capacitor C1 are not specifically limited in the disclosure.

The structure of the tuning circuit T1 is not specifically limited in the disclosure.

For example, referring to FIG. 9, the tuning circuit T1 includes a second capacitor C2 and a second inductor L2. One terminal of the second capacitor C2 is electrically connected to the first connection point E1 located between the second ground terminal A2 and the second free end D2, and the other terminal of the second capacitor C2 is grounded. One terminal of the second inductor L2 is electrically connected to the one terminal of the second capacitor C2, and the other terminal of the second inductor L2 is grounded. The inductance of the second inductor L2 and the capacitance of the second capacitor C2 are not specifically limited in the disclosure.

In an antenna assembly 100 without the resonant structure 30, the radiator 10 is provided on the first side edge 322, and the second free end D2 of the radiator 10 faces the side where the top edge 321 is located. The resonance point of the radiator 10 under excitation by the first signal source 20 is 2 GHz.

Referring to FIG. 10, a total field pattern of the radiator 10 in the antenna assembly 100 without the resonant structure 30 provided by the embodiments of the disclosure is illustrated. As can be seen from the figure, the total field pattern of the radiator 10 of the antenna assembly 100 points to the side where the top edge 321 is located and the side where the bottom edge 323 is located. In one aspect, the phase distribution of the resonant current on the radiator 10 is that the current phase of the first ground terminal A1 leads and the current phase of the first free end D1 lags, so a radiation direction toward the top edge 321 is provided. In another aspect, since the ground plate current on the reference ground plate 500 is transmitted along the longitudinal direction toward the side where the bottom edge 323 is located, a radiation direction toward the bottom edge 323 is provided.

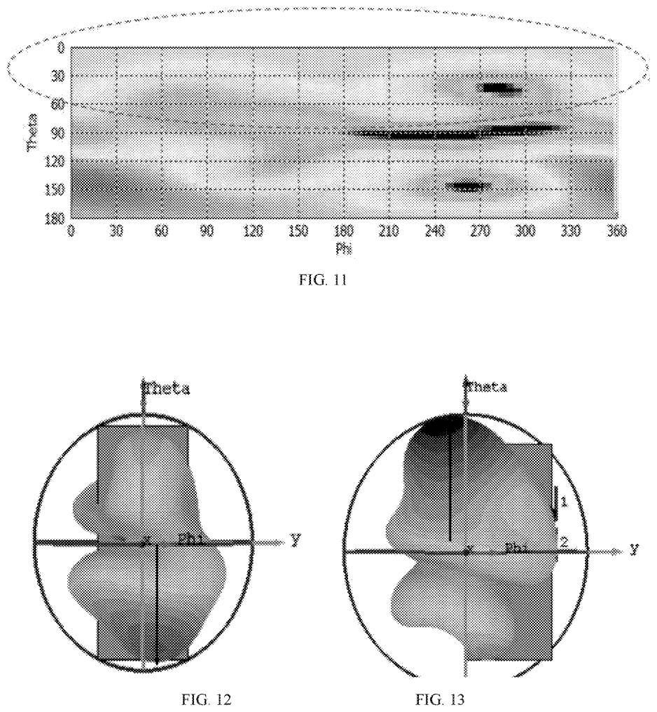

Referring to FIG. 11, a 2D radiation pattern of the radiator 10 in the antenna assembly 100 without the resonant structure 30 provided by the embodiments of the disclosure is illustrated. Theta ranging from 0° to 90° represents the energy distribution of the upper hemisphere. As can be seen from the figure, the energy distribution of the antenna assembly 100 in the upper hemisphere is less than that in the lower hemisphere.

The upper hemisphere energy ratio of the radiator 10 of this antenna assembly 100 in the Tiantong satellite frequency band is 40%. This shows that, in the antenna assembly 100 in which no resonant structure 30 is provided and the radiator 10 is provided on the first side edge 322, the upper hemisphere proportion in the radiation pattern of the electronic device 1000 in the satellite head-hand call scene is relatively low.

Referring to FIG. 12, a left-hand circular polarization radiation pattern of the radiator 10 in the antenna assembly 100 without the resonant structure 30 provided by the embodiment of the disclosure is illustrated. The left-hand circular polarization radiation pattern also points toward the bottom edge 323.

The following describes the performance such as the total field pattern and circular polarization radiation pattern of the antenna assembly 100 by taking, as an example, a case where both the first resonant structure 31 and the radiator 10 are provided on one side of the reference ground plate 500, and the center frequency of the first frequency band and the center frequency of the second frequency band are both 2 GHz.

Referring to FIG. 4 and FIG. 13, FIG. 13 illustrates a total field pattern obtained in the case where the first resonant structure 31 and the radiator 10 are both provided on the first side edge 322 and the second free end D2 of the first resonant structure 31 and the first free end D1 of the radiator 10 both face the top edge 321 as provided by the embodiments of the disclosure. As can be seen from the figure, the total field pattern of the radiator 10 of the antenna assembly 100 points to the side where the top edge 321 is located. Compared with the embodiment of the antenna assembly 100 in which no resonant structure 30 is provided and the radiator 10 is provided on the first side edge 322, the radiation energy of the antenna assembly 100 toward the bottom edge 323 is greatly reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

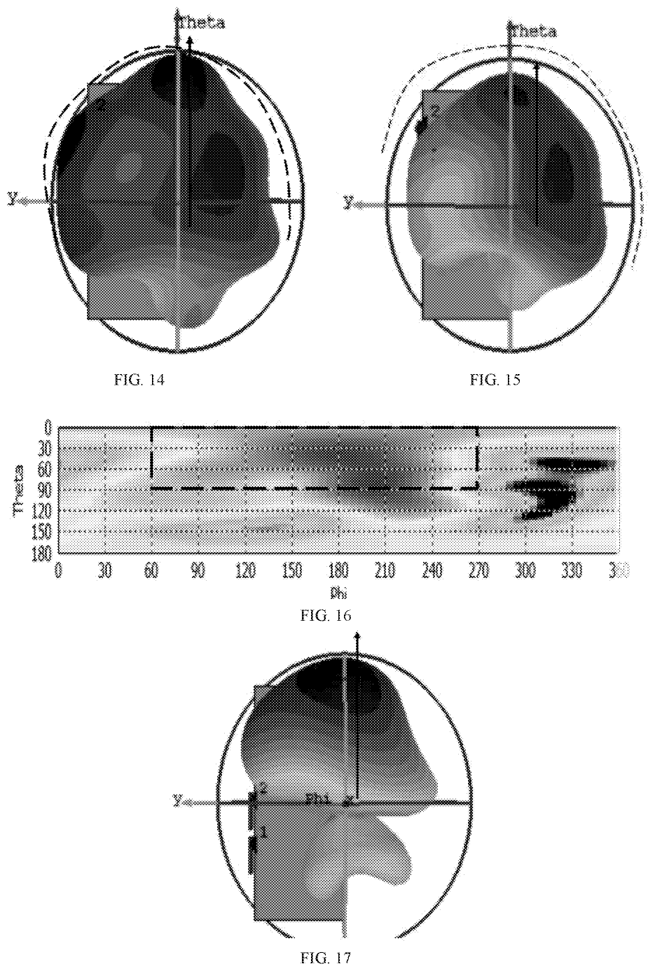

Referring to FIG. 14, another total field pattern obtained in the case where the first resonant structure 31 and the radiator 10 are both provided on the first side edge 322 and the second free end D2 of the first resonant structure 31 and the first free end D1 of the radiator 10 both face the top edge 321 as provided by the embodiments of the disclosure is illustrated. As can be seen from the total field pattern, the main radiation direction of the antenna assembly 100 is toward the top edge 321, which shows a relatively small directivity coefficient and a relatively large coverage angle (such as an angle corresponding to the dotted line in the figure). As such, it facilitates quick connection of the electronic device 1000 during satellite communication, and maintains the connection of the electronic device with the satellite when the electronic device 1000 moves with the operator during satellite communication, for example, during movement and orientation change of the electronic device 1000.

Referring to FIG. 15, a left-hand circular polarization radiation pattern obtained in the case where the first resonant structure 31 and the radiator 10 are both provided on the first side edge 322 and the second free end D2 of the first resonant structure 31 and the first free end D1 of the radiator 10 both face the top edge 321 as provided by the embodiments of the disclosure is illustrated. The total directivity gain is 2 dBi, and the left-hand circular polarization gain is 1.568 dBi. This shows that the left-hand circular polarization is the principal polarization. Left-hand circular polarized waves are mainly used for transmission during Tiantong satellite communication. As can be seen from the figure, the main direction of the left-hand circular polarization radiation pattern is upward, and there is a large coverage angle in the upward direction (such as the angle corresponding to the dotted line in the figure).

Referring to FIG. 16, a 2D left-hand circular polarization radiation pattern obtained in the case where the first resonant structure 31 and the radiator 10 are both provided on the first side edge 322 and the second free end D2 of the first resonant structure 31 and the first free end D1 of the radiator 10 both face the top edge 321 as provided by the embodiments of the disclosure is illustrated. After the first resonant structure 31 is provided, the gain of the total field radiation of the antenna assembly 100 toward the top edge 321 is increased, and the gain of circular polarization field radiation of the antenna assembly 100 toward the top edge 321 is also increased. Theta ranging from 0° to 90° represents the energy distribution of the upper hemisphere. As can be seen from the figure, the total field energy distribution of the antenna assembly 100 in the upper hemisphere is much larger than that in the lower hemisphere. Since transmission of the Tiantong satellite communication frequency band is implemented through left-hand circular polarized waves, and the upper hemisphere energy ratio of the left-hand circular polarization field energy in this embodiment is increased, the efficiency at the Tiantong satellite communication frequency band is improved.

As can be seen from the figure, there is a large energy radiation coverage angle of the left-hand circular polarized waves of the antenna assembly 100 in the upper hemisphere, which facilitates quick connection of the electronic device 1000 during Tiantong satellite communication, and maintains the connection of the electronic device with the Tiantong satellite when the electronic device 1000 moves with the operator during Tiantong satellite communication, for example, during movement and orientation change of the electronic device 1000.

Compared with the embodiment of the antenna assembly 100 in which no resonant structure 30 is provided and the radiator 10 is provided on the first side edge 322, the radiation energy of the antenna assembly 100 toward the bottom edge 323 is greatly reduced, and the main radiation direction of the antenna assembly 100 is toward the top edge 321, which facilitates the signal connection of the antenna assembly 100 with a satellite equipment at the top when the electronic device 1000 operates at the satellite communication frequency band. The upper hemisphere energy ratio of the antenna assembly 100 is 75%. Compared with the upper hemisphere energy ratio 40% of the radiator 10 without the resonant structure 30, the provision of the first resonant structure 31 provided by the embodiments of the disclosure greatly improves the upper hemisphere energy ratio.

Referring to FIG. 6 and FIG. 17, FIG. 17 illustrates a total field pattern obtained in a case where the first resonant structure 31 and the radiator 10 are both provided on the first side edge 322 and the second free end D2 of the first resonant structure 31 and the first free end D1 of the radiator 10 both face the bottom edge 323 as provided by the embodiments of the disclosure. As can be seen from the figure, the total field pattern of the radiator 10 of the antenna assembly 100 points to the side where the top edge 321 is located. Compared with the embodiment of the antenna assembly 100 in which no resonant structure 30 is provided and the radiator 10 is provided on the first side edge 322, the radiation energy of the antenna assembly 100 toward the bottom edge 323 is greatly reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

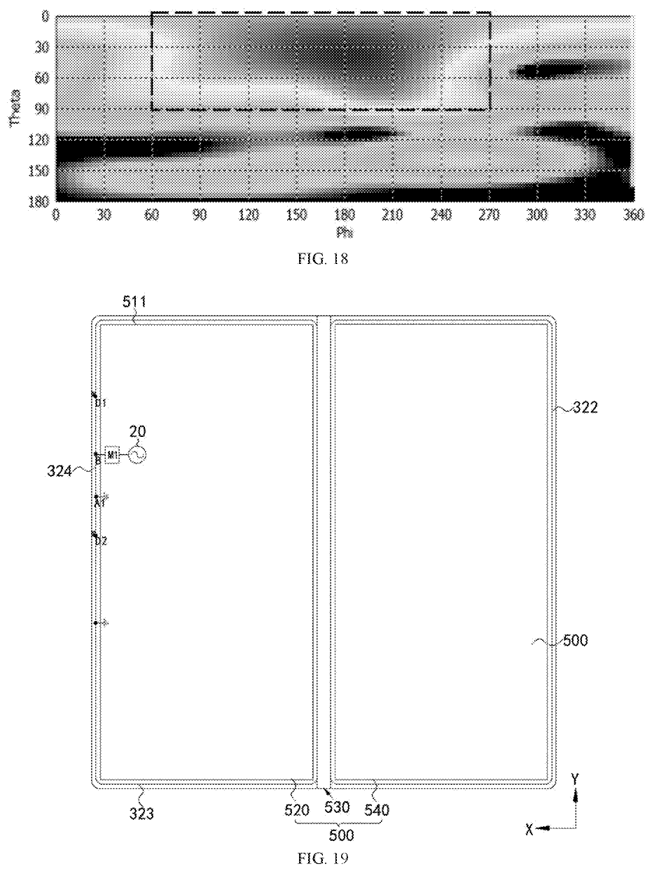

Referring to FIG. 18, a 2D radiation pattern obtained in the case where the first resonant structure 31 and the radiator 10 are both provided on the first side edge 322 and the second free end D2 of the first resonant structure 31 and the first free end D1 of the radiator 10 both face the bottom edge 323 as provided by the embodiment of the disclosure is illustrated. Theta ranging from 0° to 90° represents the energy distribution of the upper hemisphere. As can be seen from the figure, the total field energy distribution of the antenna assembly 100 in the upper hemisphere is much larger than that in the lower hemisphere.

Compared with the embodiment of the antenna assembly 100 in which no resonant structure 30 is not provided and the radiator 10 is provided on the first side edge 322, the radiation energy of the antenna assembly 100 toward the bottom edge 323 is greatly reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

The foregoing shows that, when both the first free end D1 of the radiator 10 and the second free end D2 of the first resonant structure 31 in the antenna assembly 100 face the top edge 321 or the bottom edge 323, a main radiation direction toward the top edge 321 can be provided, and a high upper hemisphere energy ratio is enabled.

The antenna assembly 100 provided by the embodiments of the disclosure can realize wide-coverage circular polarization signal transmission by designing the first resonant structure 31 and the radiator 10 to form an antenna pair.

Referring to Table 1-1, it illustrates comparisons of the efficiency in a free scene, the efficiency when a human body is close, and the SAR (specific absorption rate) value when a human body is close between the antenna assembly 100 without the first resonant structure 31 and the antenna assembly 100 in which the first resonant structure 31 and the radiator 10 form an antenna pair as provided by the embodiment of the disclosure. In the case where the first resonant structure 31 and the radiator 10 form an antenna pair, the efficiency in the free scene and the efficiency when the human body is close are both increased, and the SAR value when the human body is close is reduced, thereby reducing the risk of excessive SAR.

TABLE 1-1

| | Total | Total | SAR value |
|---|---|---|---|
| | efficiency | efficiency | when human |
| | in free | when human | body is close |
| | scene | body is close | (0.25 W) |
| No first resonant structure 31 | −1.96 dB | −6.049 dB | 1.65605 |
| is provided | | | |
| First resonant structure 31 and | −0.96 dB | −5.65 dB | 1.65497 |
| radiator 10 form antenna pair | | | |

In some implementations, the electronic device 1000 may be a non-foldable device or a foldable device.

When the electronic device 1000 is a foldable device, the reference ground plate 500 includes a first ground plate 520, a rotating shaft 530 and a second ground plate 540 connected in sequence, and the at least one resonant structure 30 and the radiator 10 are both located on a same side of the rotating shaft 530.

Referring to FIG. 19, a schematic structural diagram in which the first resonant structure 31 and the radiator 10 are provided on the same side of the rotating shaft 530 as provided by the embodiment of the disclosure is illustrated.

Referring to FIG. 20, a total radiation pattern of the antenna assembly 100 without the resonant structure 30 in the foldable device as provided by the embodiments of the disclosure is illustrated. As can be seen from the figure, when the electronic device 1000 is a foldable device, the width size of the reference ground plate 500 increases. The total field pattern of the radiator 10 of the antenna assembly 100 mainly points to the side where the bottom edge 323 is located. In this case, the upper hemisphere energy ratio of the antenna assembly 100 is 30%.

Referring to FIG. 21, a first total field radiation pattern obtained in a case where the first resonant structure 31 and the radiator 10 are provided on the same side of the rotating shaft 530 in the foldable device as provided by the embodiment of the disclosure is illustrated. As can be seen from the figure, when the electronic device 1000 is a foldable device, the width size of the reference ground plate 500 increases. Due to the provision of the first resonant structure 31, under the action of the first resonant structure 31, the total field pattern of the radiator 10 of the antenna assembly 100 mainly points to the side where the top edge 321 is located. In this case, the upper hemisphere energy ratio of the antenna assembly 100 is 63%.

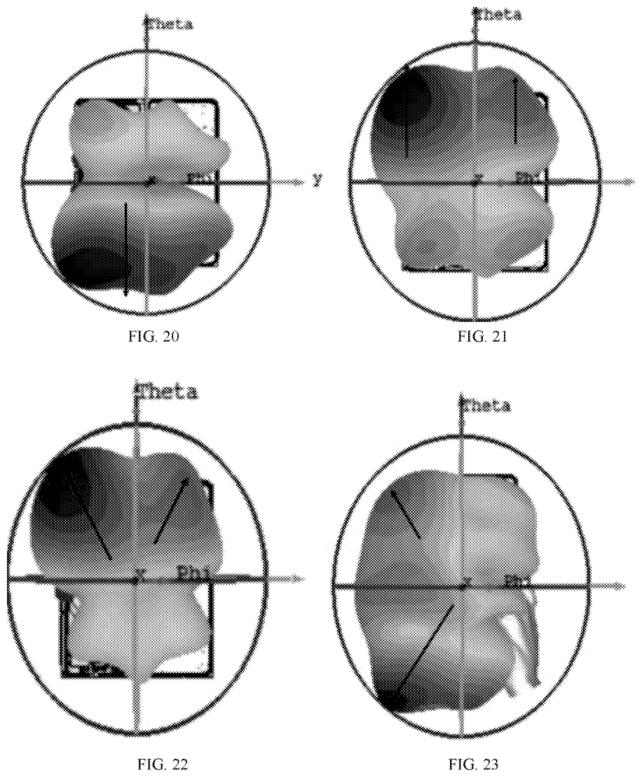

Referring to FIG. 22, a second total field radiation pattern obtained in the case where the first resonant structure 31 and the radiator 10 are provided on the same side of the rotating shaft 530 in the foldable device as provided by the embodiment of the disclosure is illustrated. As can be seen from the figure, when the electronic device 1000 is a foldable device, the width size of the reference ground plate 500 increases. By tuning the tuning circuit T1 electrically connected with the first resonant structure 31 to tune the second frequency point to an appropriate frequency point, the coupling between the first resonant structure 31 and the radiator 10 reaches an appropriate degree, which can improve the efficiency of the first frequency band, thereby improving the upward radiation gain. In this case, the upper hemisphere energy ratio of the antenna assembly 100 is 72%.

Referring to FIG. 23, a third total field radiation pattern of the antenna assembly 100 without the resonant structure 30 in the foldable device as provided by the embodiment of the disclosure is illustrated. When the electronic device 1000 is in a hand-held state and a finger is placed over the radiator 10, compared with the case being in the free scene, the upward radiation amount of the radiation pattern increases, and the main radiation direction still faces the bottom edge 323. In this case, the upper hemisphere energy ratio is 45%.

Referring to FIG. 24, a left-hand circular polarization radiation pattern of the antenna assembly 100 without the resonant structure 30 in the foldable device as provided by the embodiments of the disclosure is illustrated. When the electronic device 1000 is in the hand-held state and a finger is placed over the radiator 10, compared with the case being in the free scene, the upward radiation amount of the radiation pattern increases, and the upward radiation component of the left-hand circular polarization radiation also increases.

Referring to FIG. 25, a fourth total field radiation pattern obtained in the case where the first resonant structure 31 and the radiator 10 are provided on the same side of the rotating shaft 530 in the foldable device as provided by the embodiments of the disclosure is illustrated. When the electronic device 1000 is in the hand-held state and a finger is placed over the first resonant structure 31, compared with the embodiment in which no first resonant structure 31 is provided, the upward radiation energy increases, the main radiation direction faces the top edge 321, and the upper hemisphere energy ratio increases to 51.7%.

Referring to FIG. 26, a left-hand circular polarization field radiation pattern obtained in the case where the first resonant structure 31 and the radiator 10 are provided on the same side of the rotating shaft 530 in the foldable device as provided by the embodiment of the disclosure is illustrated. When the electronic device 1000 is in the hand-held state and a finger is placed over the first resonant structure 31, compared with the embodiment in which no first resonant structure 31 is provided, the upward radiation energy increases, the main radiation direction faces the top edge 321, and the proportion of left-hand circular polarization also increases. As can be seen, the left-hand circular polarization field radiation direction mainly faces the top edge 321.

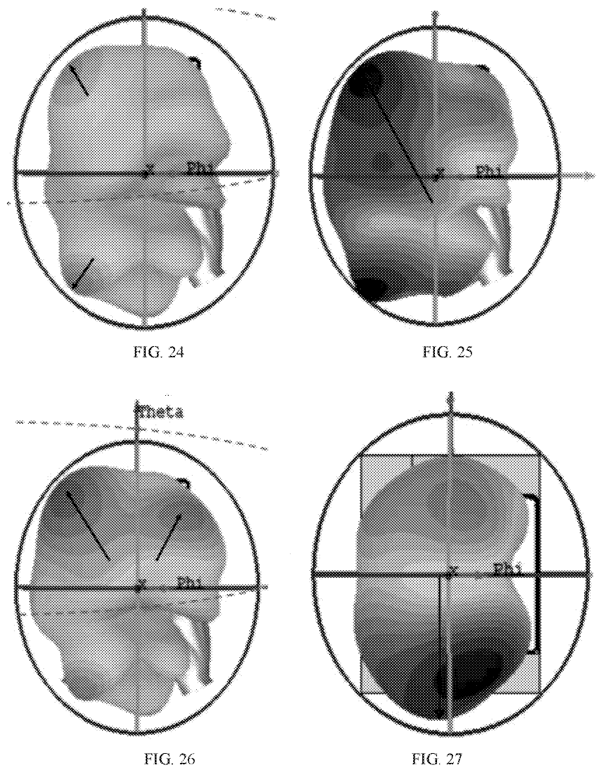

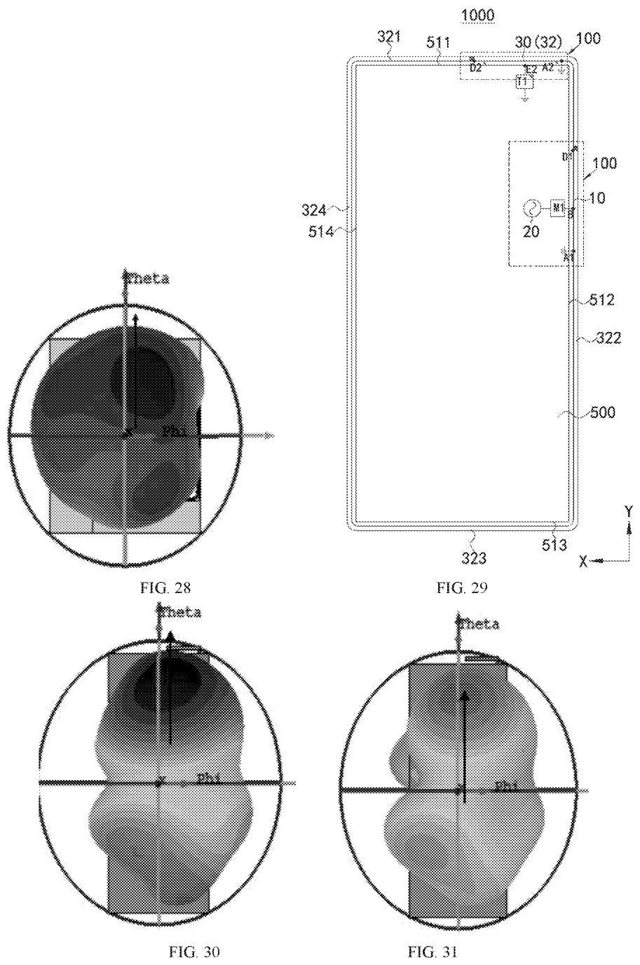

Referring to FIG. 27, a total field radiation pattern obtained when the antenna assembly 100 without the resonant structure 30 in the foldable device is close to the head as provided by the embodiment of the disclosure is illustrated. As can be seen, the total field pattern of the radiator 10 of the antenna assembly 100 mainly points to the side where the bottom edge 323 is located.

Referring to FIG. 28, a total field radiation pattern obtained in the case where the first resonant structure 31 and the radiator 10 are provided on the same side of the rotating shaft 530 in the foldable device as provided by the embodiment of the disclosure is illustrated. Under the action of the first resonant structure 31 and the head dielectric loading, the radiation pattern of the antenna assembly 100 mainly faces the top edge 321, and there is a large coverage angle in the upward radiation direction.

Referring to Table 1-2, it illustrates comparisons of the efficiency in a free scene, the efficiency when a human body is close, and the SAR value when a human body is close between the antenna assembly 100 without the first resonant structure 31 and the antenna assembly 100 in which the first resonant structure 31 and the radiator 10 form an antenna pair as provided by the embodiments of the disclosure. In the case where the first resonant structure 31 and the radiator 10 form an antenna pair, the efficiency in the free scene and the efficiency when the human body is close are both increased, and the SAR value when the human body is close is reduced, thereby reducing the risk of excessive SAR.

TABLE 1-2

| | Total | Total | SAR value |
|---|---|---|---|
| | efficiency | efficiency | when human |
| | in free | when human | body is close |
| | scene | body is close | (0.25 W) |
| No first resonant structure 31 | −1.93 dB | −12.88 dB | 14.4807 |
| is provided | | | |
| First resonant structure 31 and | −1.8 dB | −11.38 dB | 14.4641 |
| radiator 10 form antenna pair | | | |

Referring to FIG. 29, a schematic structural diagram in which the resonant structure 30 is provided on the top edge 321 is illustrated.

In some implementations, referring to FIG. 29, the at least one resonant structure 30 includes a second resonant structure 32. The second resonant structure 32 is provided on the side where the top edge 321 is located. Specifically, the second resonant structure 32 may be provided on the reference ground plate 500 on the side where the top edge 321 is located or on the top edge 321. The description of the structure and function of the second resonant structure 32 may refer to the description of the structure and function of the first resonant structure 31.

The second free end D2′ of the second resonant structure 32 faces the side where the second side edge 324 is located. The first free end D1 of the radiator 10 faces the side where the top edge 321 is located. That is, the first free end D1 of the radiator 10 is relatively close to the second ground terminal A2′ of the second resonant structure 32 to form a magnetic field-electric field coupling structure.

The second resonant structure 32 is configured to guide the ground plate current to be distributed in an area close to the first ground plate edge 511, so as to increase the ground plate current intensity of the reference ground plate 500 in the area close to the first ground plate edge 511, thereby enhancing the radiation pattern toward the top edge 321 and improving the upper hemisphere energy ratio.

In some implementations, the distance between the second resonant structure 32 and the first side edge 322 is smaller than the distance between the second resonant structure 32 and the second side edge 324. In other words, the second resonant structure 32 is located on a side of the top edge 321 close to the radiator 10. Further, the second ground terminal A2 is located at a position of the top edge 321 close to the first side edge 322. Since the ground plate current on the side of the first ground plate edge 511 close to the radiator 10 is relatively strong, by providing the second resonant structure 32 on the side close to the radiator 10, it makes the second resonant structure 32 easier to be excited by the ground plate current and generate resonance. Moreover, the coupling effect between the second resonant structure 32 and the radiator 10 is enhanced, and more ground plate current is guided to the upper half of the reference ground plate 500, which further enhances the radiation pattern pointing to the top edge 321 and improves the upper hemisphere energy ratio.

Under the excitation of the first signal source 20, the first resonant current is generated on the radiator 10, and the ground plate current is generated on the reference ground plate 500. The ground plate current includes a first sub-current and a second sub-current. The first sub-current is distributed between the first ground terminal A1 and the first ground plate edge 511. The second sub-current is distributed between the first ground terminal A1 and the third ground plate edge 513. The second resonant structure 32 guides more ground plate current on the reference ground plate 500 to the vicinity of the second resonant structure 32, so that the current intensity of the first sub-current is greater than that of the second sub-current, and the current intensity of the upper half of the reference ground plate 500 is greater than that of the lower half of the reference ground plate 500, thereby enhancing the radiation toward the top edge 321 and improving the upper hemisphere energy ratio.

Referring to FIG. 30, a total field pattern of the second resonant structure 32 and the radiator 10 as provided by the embodiments of the disclosure is illustrated. As can be seen from the figure, the total field pattern of the radiator 10 of the antenna assembly 100 mainly points to the side where the top edge 321 is located. Compared with the embodiment of the antenna assembly 100 in which no resonant structure 30 is provided and the radiator 10 is provided on the first side edge 322, the radiation energy of the antenna assembly 100 toward the bottom edge 323 is greatly reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

Referring to FIG. 31, a 3D left-hand circular polarization radiation pattern of the second resonant structure 32 and the radiator 10 as provided by the embodiments of the disclosure is illustrated. As can be seen from the figure, the left-hand circular polarization component radiation pattern of the radiator 10 of the antenna assembly 100 mainly points to the side where the top edge 321 is located. Compared with the embodiment of the antenna assembly 100 in which no resonant structure 30 is provided and the radiator 10 is provided on the first side edge 322, the left-hand circular polarization radiation energy of the antenna assembly 100 toward the bottom edge 323 is greatly reduced, and the main radiation direction of the left-hand circular polarization component of the antenna assembly 100 is toward the top edge 321. Left-hand circular polarized waves are mainly used for transmission in Tiantong satellite communication. As such, when the electronic device 1000 operates at the Tiantong satellite communication frequency band, the signal connection of the antenna assembly 100 with a Tiantong satellite equipment at the top is facilitated.

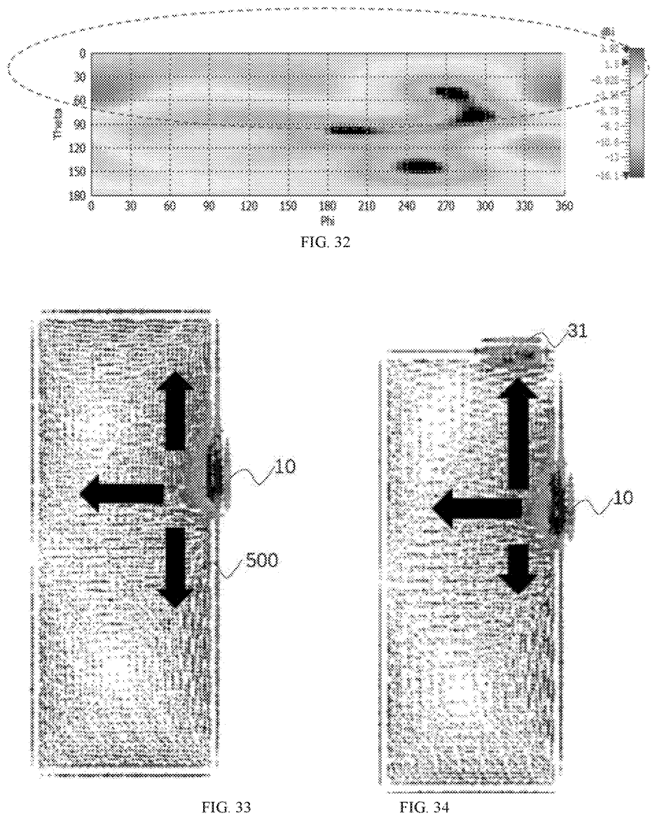

Referring to FIG. 32, a 2D left-hand circular polarization radiation pattern of the second resonant structure 32 and the radiator 10 as provided by the embodiments of the disclosure is illustrated. In the case where the second resonant structure 32 is provided, the total gain of radiation of the antenna assembly 100 toward the top edge 321 is increased, and the gain of left-hand circular polarization field radiation of the antenna assembly 100 toward the top edge 321 is also increased. Theta ranging from 0° to 90° represents the left-hand circular polarization energy distribution of the upper hemisphere. As can be seen from the figure, the left-hand circular polarization energy distribution of the antenna assembly 100 in the upper hemisphere is much larger than that in the lower hemisphere. Since transmission of the Tiantong satellite communication frequency band is implemented through left-hand circular polarized waves, and the upper hemisphere energy ratio of the left-hand circular polarization field energy in this embodiment is increased, it improves the efficiency of the Tiantong satellite communication frequency band.

Referring to FIG. 33, a schematic current distribution diagram of the radiator 10 in the antenna assembly 100 without the resonant structure 30 and the reference ground plate 500 as provided by the embodiments of the disclosure is illustrated. As can be seen from the figure, the current on the reference ground plate 500 includes a longitudinal current flowing to the first ground plate edge 511, a longitudinal current flowing to the third ground plate edge 513, and a transverse current flowing to the second side edge 324. The intensity of the longitudinal current flowing to the first ground plate edge 511 and the longitudinal current flowing to the third ground plate edge 513 are both relatively strong. It shows that, when there is no second resonant structure 32, the longitudinal current along the long side edge and the transverse current along the short side plate are excited, forming upward and downward antenna radiation.

Referring to FIG. 34, a schematic current distribution diagram of the second resonant structure 32, the radiator 10 and the reference ground plate 500 as provided by the embodiments of the disclosure is illustrated. As can be seen from the figure, the current on the reference ground plate 500 includes a longitudinal current flowing to the first ground plate edge 511, a longitudinal current flowing to the third ground plate edge 513, and a transverse current flowing to the second side edge 324. The intensity of the longitudinal current flowing to the first ground plate edge 511 is much greater than that of the longitudinal current flowing to the third ground plate edge 513. Due to the existence of the second resonant structure 32 at the top, the longitudinal current on the upper half of the reference ground plate 500 along the long side is enhanced, and the longitudinal current on the lower half of the reference ground plate 500 is weakened, forming upward antenna radiation.

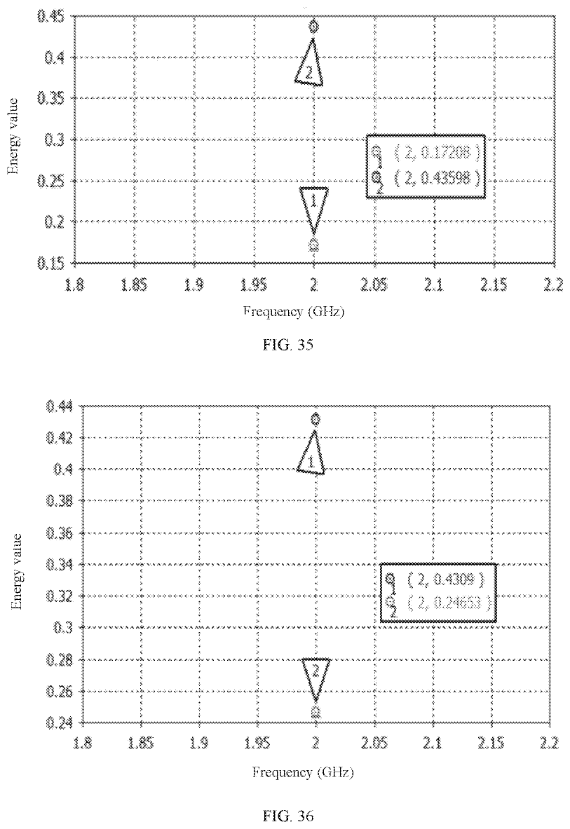

Referring to FIG. 35, an upper hemisphere radiation ratio of the antenna assembly 100 without the resonant structure 30 as provided by the embodiments of the disclosure is illustrated. As can be seen from the figure, point 1 represents the upward radiation energy, and point 2 represents the total radiation energy. The upper hemisphere radiation ratio of the antenna assembly 100 without the resonant structure 30 is 40%.

Referring to FIG. 36, an upper hemisphere radiation ratio of the antenna assembly 100 in which the second resonant structure 32 located on the top edge 321 and the radiator 10 form an antenna pair as provided by the embodiments of the disclosure is illustrated. As can be seen from the figure, point 2 represents the upward radiation energy, and point 1 represents the total radiation energy. The upper hemisphere radiation ratio of the antenna assembly 100 is 57%.

The antenna assembly 100 provided by the embodiments of the disclosure can improve the circular polarization directivity and the upper hemisphere radiation ratio of the side antenna of the electronic device 1000. Compared with the case where the main radiator 10 is located at the top side, the main radiator 10 being located at the long side of the electronic device 1000 reduces the SAR backoff in the head-hand call mode and is more suitable for the head-hand call mode. The resonant structure 30 is provided at a specific position on the top of the electronic device 1000. Due to the guiding effect of the top resonant structure 30 on the ground plate current, the longitudinal current of the upper half of the electronic device 1000 is enhanced, thereby improving the upper hemisphere radiation ratio and circular polarization antenna gain of the electronic device 1000 and enhancing the user experience.

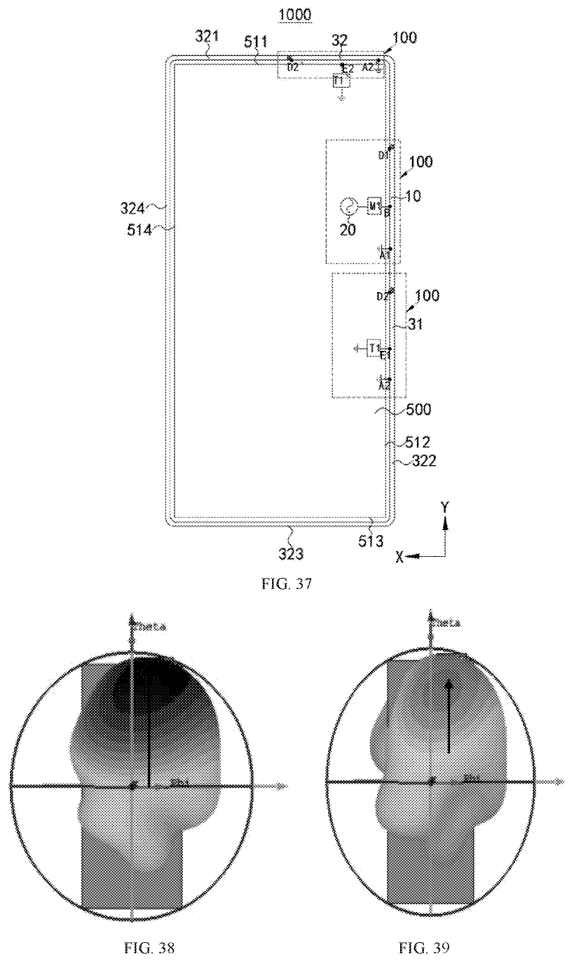

Referring to FIG. 37, a schematic structural diagram in which the antenna assembly 100 includes both the first resonant structure 31 and the second resonant structure 32 as provided by the embodiments of the disclosure is illustrated. The at least one resonant structure 30 includes a first resonant structure 31 and a second resonant structure 32. The first resonant structure 31 is provided on the side where the first side edge 322 is located. The direction from the second ground terminal A2 to the second free end D2 of the first resonant structure 31 is the same as the direction from the second ground terminal A2 to the first free end D1 of the radiator 10. The second resonant structure 32 is provided on the side where the top edge 321 is located. Specifically, the second resonant structure 32 may be provided on the reference ground plate 500 on the side where the top edge 321 is located or on the top edge 321. The description of the structure and function of the second resonant structure 32 may refer to the description of the structure and function of the first resonant structure 31. The second free end D2′ of the second resonant structure 32 faces the side where the second side edge 324 is located. The first free end D1 of the radiator 10 faces the side where the top edge 321 is located. That is, the first free end D1 of the radiator 10 is relatively close to the second ground terminal A2′ of the second resonant structure 32 to form a magnetic field-electric field coupling structure.

The second resonant structure 32 is configured to guide the ground plate current to be distributed in an area close to the first ground plate edge 511, so as to increase the ground plate current intensity of the reference ground plate 500 in the area close to the first ground plate edge 511, thereby enhancing the radiation pattern pointing to the top edge 321 and improving the upper hemisphere energy ratio.

Referring to FIG. 38, a total field pattern of the first resonant structure 31, the second resonant structure 32 and the radiator 10 as provided by the embodiments of the disclosure is illustrated. As can be seen from the figure, the total field pattern of the radiator 10 of the antenna assembly 100 mainly points to the side where the top edge 321 is located. The downward side lobes are further reduced. Compared with the embodiment of the antenna assembly 100 in which no resonant structure 30 is provided and the radiator 10 is provided on the first side edge 322, the radiation energy of the antenna assembly 100 toward the bottom edge 323 is further reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

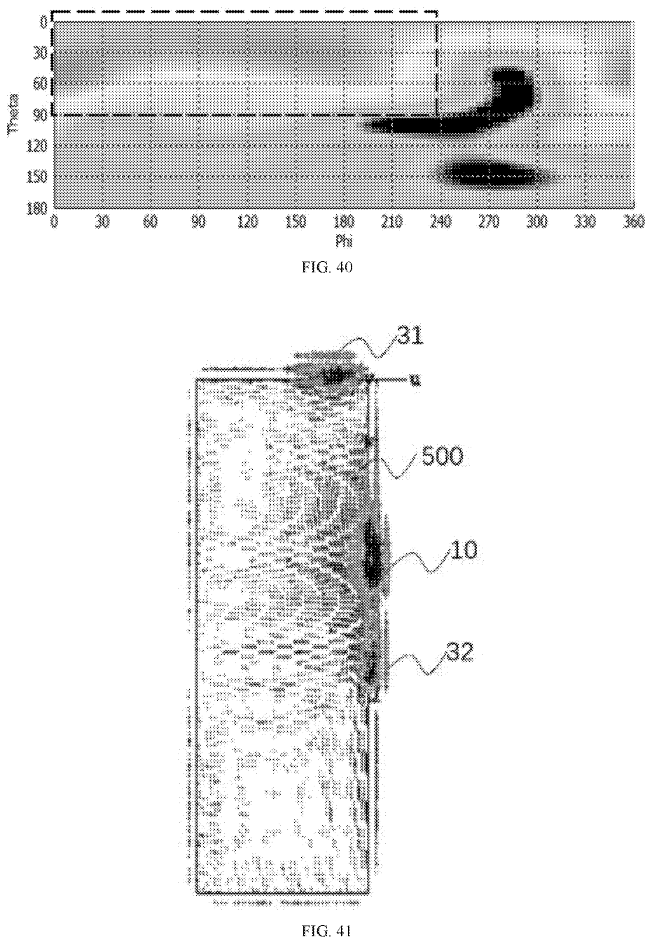

Referring to FIG. 39, a 3D left-hand circular polarization radiation pattern of the first resonant structure 31, the second resonant structure 32 and the radiator 10 as provided by the embodiments of the disclosure is illustrated. As can be seen from the figure, the radiation pattern of the left-hand circular polarization components of the radiator 10 of the antenna assembly 100 mainly points to the side where the top edge 321 is located, and the downward side lobes in the left-hand circular polarization field are further reduced. Compared with the embodiment of the antenna assembly 100 in which no resonant structure 30 is provided and the radiator 10 is provided on the first side edge 322, the left-hand circular polarization radiation energy of the antenna assembly 100 toward the bottom edge 323 is further reduced, and the main radiation direction of the left-hand circular polarization component of the antenna assembly 100 is toward the top edge 321. Left-hand circular polarized waves are mainly used for transmission in Tiantong satellite communication. As such, it facilitates the signal connection of the antenna assembly 100 with a Tiantong satellite equipment at the top, when the electronic device 1000 operates at the Tiantong satellite communication frequency band.

Referring to FIG. 40, a 2D left-hand circular polarization radiation pattern of the first resonant structure 31, the second resonant structure 32 and the radiator 10 as provided by the embodiments of the disclosure is illustrated. In the case where the first resonant structure 31 and the second resonant structure 32 are provided, the total gain of radiation of the antenna assembly 100 toward the top edge 321 is further increased, and the gain of left-hand circular polarization field radiation of the antenna assembly 100 toward the top edge 321 is also further increased. Theta ranging from 0° to 90° represents the left-hand circular polarization energy distribution of the upper hemisphere. As can be seen from the figure, the left-hand circular polarization energy distribution of the antenna assembly 100 in the upper hemisphere is much larger than that in the lower hemisphere. Since transmission of the Tiantong satellite communication frequency band is implemented through left-hand circular polarized waves, and the upper hemisphere energy ratio of the left-hand circular polarization field energy in this embodiment is increased, it improves the efficiency of the Tiantong satellite communication frequency band.

Referring to FIG. 41, a schematic current distribution diagram of the first resonant structure 31, the second resonant structure 32, the radiator 10 and the reference ground plate 500 as provided by the embodiments of the disclosure is illustrated. As can be seen from the figure, the current on the reference ground plate 500 is mainly concentrated near the radiator 10, the first resonant structure 31 and the second resonant structure 32, in which the first resonant structure 31, the second resonant structure 32 and the radiator 10 all resonate. A phase-leading current is generated on the first resonant structure 31, and a phase-lagging current is generated on the radiator 10, forming a radiation direction toward the top edge 321. The second resonant structure 32 increases the longitudinal current intensity of the upper half of the reference ground plate 500, reduces the longitudinal current intensity of the lower half of the reference ground plate 500, reduces the longitudinal current flowing to the bottom edge 323, and improves the upward radiation. Under the above dual enhancement effects, upward radiation toward the top edge 321 is provided, and a large upper hemisphere energy ratio is enabled.

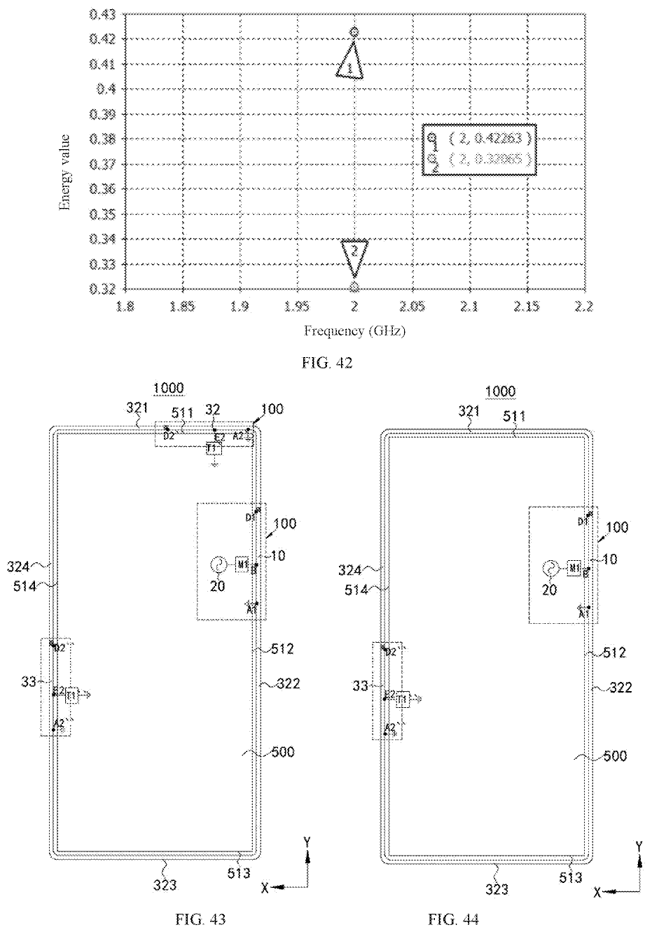

Referring to FIG. 42, an upper hemisphere radiation ratio of the antenna assembly 100 in which the first resonant structure 31, the second resonant structure 32 and the radiator 10 form an antenna cluster as provided by the embodiments of the disclosure is illustrated. The first resonant structure 31 and the second resonant structure 32 further improve the performance, and the longitudinal current of the lower half is further suppressed by the resonant structure 30 on the long side. As can be seen from the figure, point 2 represents the upward radiation energy, and point 1 represents the total radiation energy. The upper hemisphere radiation ratio of the antenna assembly 100 is further increased to 75.8%.

Referring to FIG. 43, a schematic structural diagram in which the resonant structure 30 is provided on the second side edge 324 is illustrated.

In some implementations, referring to FIG. 43, the at least one resonant structure 30 includes a third resonant structure 33. The third resonant structure 33 is provided on the side where the second side edge 324 is located. Specifically, the third resonant structure 33 may be provided on the reference ground plate 500 on the side where the second side edge 324 is located or on the second side edge 324. The structure and function of the third resonant structure 33 may refer to those of the first resonant structure 31. Due to provision of the third resonant structure 33, the third resonant structure 33 is configured to increase the transverse current on the reference ground plate 500, thereby improving the upward radiation. The direction of the transverse current is a direction along the first ground plate edge 511. For example, the transverse current on the reference ground plate 500 is close to half a wavelength at the first frequency band, and the reference ground plate 500 is approximately a dipole structure. According to the radiation pattern of the dipole structure, an upward radiation pattern is provided.

In some implementations, referring to FIG. 44, the direction from the second ground terminal A2″ to the second free end D2″ of the third resonant structure 33 is the same as the direction from the first ground terminal A1 to the first free end D1 of the radiator 10. That is, the free end of the third resonant structure 33 faces the same direction as the free end of the first resonant structure 31, for example, both of them face the top edge 321. The position of the third resonant structure 33 is not specifically limited in the disclosure. In some implementations, the third resonant structure 33 may be provided on the lower half of the reference ground plate 500 (close to the bottom edge 323), the upper half of the reference ground plate 500 (close to the top edge 321), or at a position directly opposite (or nearly directly opposite) to the radiator 10.

In some implementations, the at least one resonant structure 30 includes the first resonant structure 31, the second resonant structure 32 and the third resonant structure 33. The first resonant structure 31 is provided on the side where the first side edge 322 is located. The direction from the second ground terminal A2 to the second free end D2 of the first resonant structure 31 is the same as the direction from the first ground terminal A1 to the first free end D1 of the radiator 10. The second resonant structure 32 is provided on the side where the top edge 321 is located. Specifically, the second resonant structure 32 may be provided on the reference ground plate 500 on the side where the top edge 321 is located or on the top edge 321. The second free end D2′ of the second resonant structure 32 faces the side where the second side edge 324 is located. The first free end D1 of the radiator 10 faces the side where the top edge 321 is located. The second resonant structure 32 is configured to guide the ground plate current to be distributed in an area close to the first ground plate edge 511, so as to increase the ground plate current intensity of the reference ground plate 500 in the area close to the first ground plate edge 511, thereby enhancing the radiation pattern pointing to the top edge 321 and improving the upper hemisphere energy ratio.

The third resonant structure 33 is provided on the side where the second side edge 324 is located. Specifically, the third resonant structure 33 may be provided on the reference ground plate 500 on the side where the second side edge 324 is located or on the second side edge 324. Due to the provision of the third resonant structure 33, the third resonant structure 33 is configured to increase the transverse current on the reference ground plate 500, thereby improving the upward radiation. The direction of the transverse current is a direction along the first ground plate edge 511. The direction from the second ground terminal A2″ to the second free end D2″ of the third resonant structure 33 is the same as the direction from the first ground terminal A1 to the first free end D1 of the radiator 10.

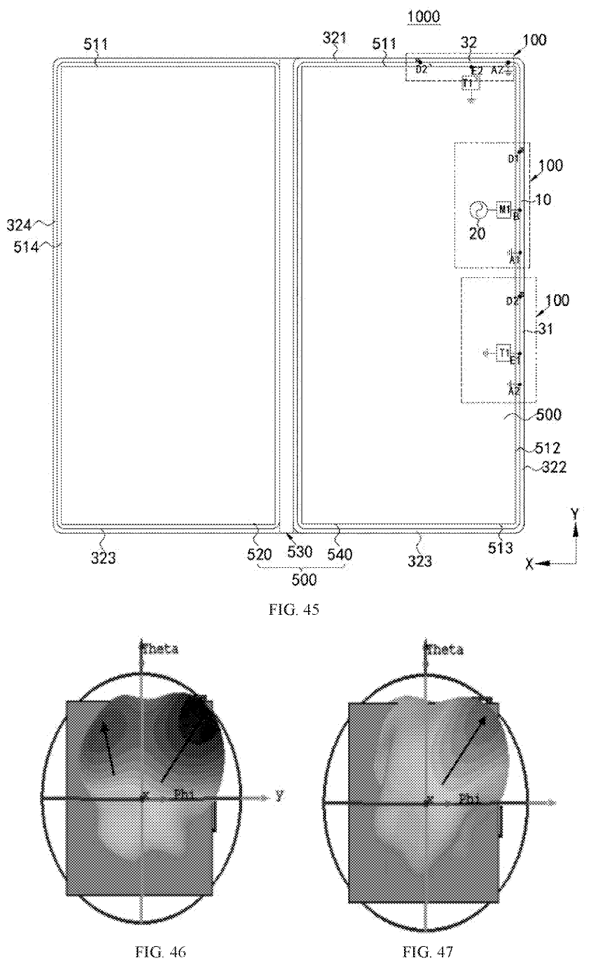

Referring to FIG. 45, when the electronic device 1000 is a foldable device, the reference ground plate 500 includes a first ground plate 520, a rotating shaft 530 and a second ground plate 540 connected in sequence, and the at least one resonant structure 30 and the radiator 10 are both located on the same side of the rotating shaft 530.

In some implementations, referring to FIG. 45, the first resonant structure 31, the second resonant structure 32 and the radiator 10 are all located on the same side of the rotating shaft 530.

Referring to FIG. 46, a total field pattern obtained in the case where the first resonant structure 31, the second resonant structure 32 and the radiator 10 are provided on the same side of the rotating shaft 530 in the foldable device as provided by the embodiments of the disclosure is illustrated. As can be seen from the figure, the total field pattern of the radiator 10 of the antenna assembly 100 mainly points to the side where the top edge 321 is located. The downward side lobes are further reduced. Compared with the embodiment of the antenna assembly 100 in which no resonant structure 30 is provided and the radiator 10 is provided on the first side edge 322, the radiation energy of the antenna assembly 100 toward the bottom edge 323 is further reduced, and the main radiation direction of the antenna assembly 100 is toward the top edge 321, which facilitates the signal connection of the antenna assembly 100 with a satellite equipment at the top when the electronic device 1000 operates at the satellite communication frequency band.

Referring to FIG. 47, a 3D left-hand circular polarization radiation pattern obtained in the case where the first resonant structure 31, the second resonant structure 32 and the radiator 10 are provided on the same side of the rotating shaft 530 in the foldable device as provided by the embodiments of the disclosure is illustrated. As can be seen from the figure, the radiation pattern of the left-hand circular polarization components of the radiator 10 of the antenna assembly 100 mainly points to the top edge 321 and is biased toward the first side edge 322, and the downward side lobes in the left-hand circular polarization field are further reduced. Compared with the embodiment of the antenna assembly 100 in which no resonant structure 30 is provided and the radiator 10 is provided on the first side edge 322, the left-hand circular polarization radiation energy of the antenna assembly 100 toward the bottom edge 323 is further reduced, and the main radiation direction of the left-hand circular polarization component of the antenna assembly 100 is toward the top edge 321 and biased toward the first side edge 322. Left-hand circular polarized waves are mainly used for transmission in Tiantong satellite communication. As such, it facilitates the signal connection of the antenna assembly 100 with a Tiantong satellite equipment at the top when the electronic device 1000 operates at the Tiantong satellite communication frequency band.

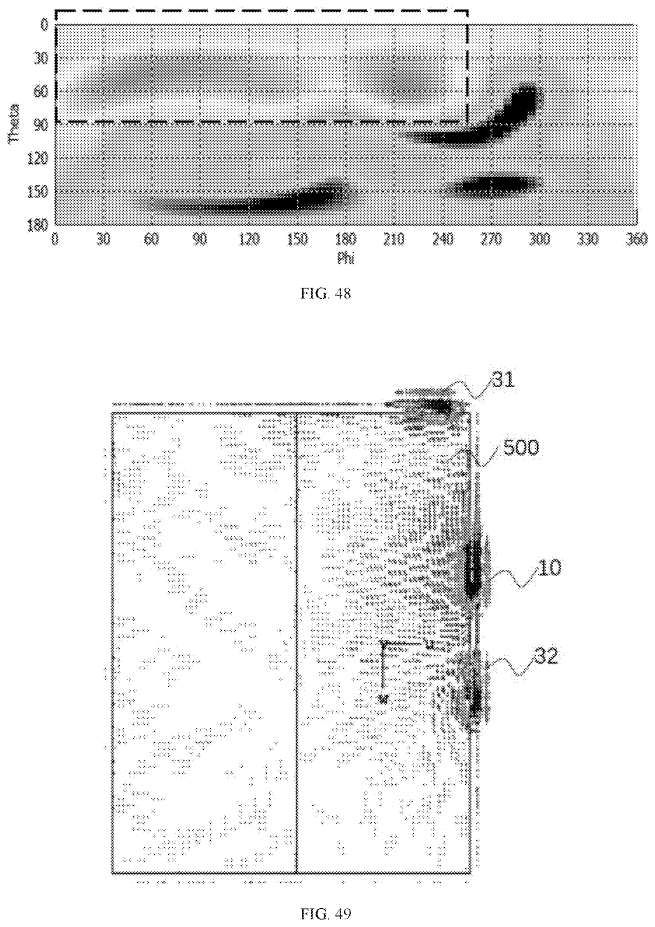

Referring to FIG. 48, a 2D left-hand circular polarization radiation pattern obtained in a case where the first resonant structure 31, the second resonant structure 32 and the radiator 10 are provided on the same side of the rotating shaft 530 in the foldable device as provided by the embodiments of the disclosure is illustrated. In the case where the first resonant structure 31 and the second resonant structure 32 are provided, the total gain of radiation of the antenna assembly 100 toward the top edge 321 is further increased, and the gain of left-hand circular polarization field radiation of the antenna assembly 100 toward the top edge 321 is also further increased. Theta ranging from 0° to 90° represents the left-hand circular polarization energy distribution of the upper hemisphere. As can be seen from the figure, the left-hand circular polarization energy distribution of the antenna assembly 100 in the upper hemisphere is much larger than that in the lower hemisphere. Since transmission of the Tiantong satellite communication frequency band is implemented through left-hand circular polarized waves, and the upper hemisphere energy ratio of the left-hand circular polarization field energy in this embodiment is increased, it improves the efficiency of the Tiantong satellite communication frequency band.

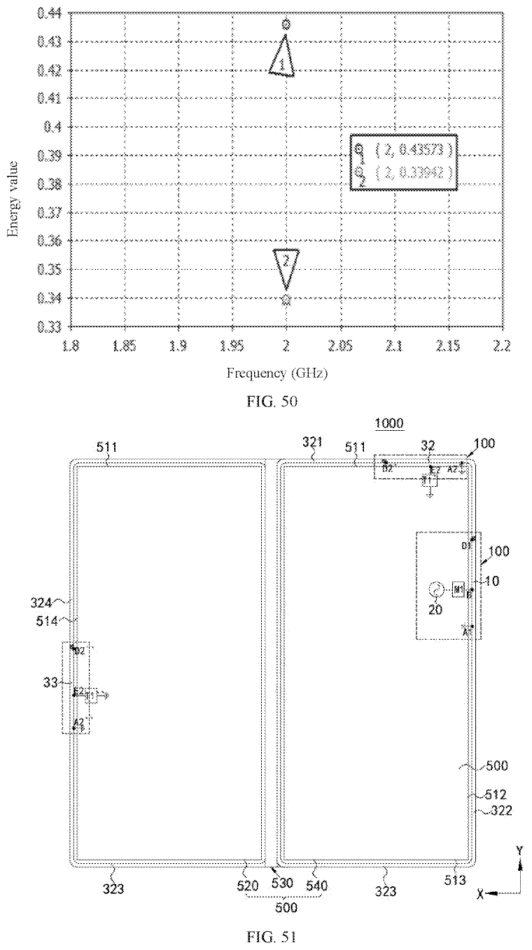

Referring to FIG. 49, a schematic current distribution diagram obtained in the case where the first resonant structure 31, the second resonant structure 32 and the radiator 10 are provided on the same side of the rotating shaft 530 in the foldable device as provided by the embodiments of the disclosure is illustrated. As can be seen from the figure, the current on the reference ground plate 500 is mainly concentrated near the radiator 10, the first resonant structure 31 and the second resonant structure 32, in which the first resonant structure 31, the second resonant structure 32 and the radiator 10 all resonate. A phase-leading current is generated on the first resonant structure 31, and a phase-lagging current is generated on the radiator 10, forming a radiation direction toward the top edge 321. The second resonant structure 32 increases the longitudinal current intensity of the upper half of the reference ground plate 500, reduces the longitudinal current intensity of the lower half of the reference ground plate 500, reduces the longitudinal current flowing to the bottom edge 323, and improves the upward radiation. Under the above dual enhancement effects, upward radiation toward the top edge 321 is provided, and a large upper hemisphere energy ratio is enabled.

Referring to FIG. 50, an upper hemisphere radiation ratio obtained in the case where the first resonant structure 31, the second resonant structure 32 and the radiator 10 are provided on the same side of the rotating shaft 530 in the foldable device as provided by the embodiments of the disclosure is illustrated. The first resonant structure 31 and the second resonant structure 32 further improve the performance, and the longitudinal current of the lower half is further suppressed by the resonant structure 30 on the long side. As can be seen from the figure, point 2 represents the upward radiation energy, and point 1 represents the total radiation energy. The upper hemisphere radiation ratio of the antenna assembly 100 is further increased to 77.9%.

In some implementations, referring to FIG. 51, the reference ground plate 500 includes a first ground plate 520, a rotating shaft 530 and a second ground plate 540 connected in sequence. The second resonant structure 32 provided on the side where the top edge 321 is located and the radiator 10 are located on the same side of the rotating shaft 530. The third resonant structure 33 provided on the side where the second side edge 324 is located and the radiator 10 are located on opposite sides of the rotating shaft 530 respectively.

Further, when the first ground plate 520 and the second ground plate 540 are in a folded state, the resonant structure 30 provided on the side where the second side edge 324 is located is located on a side of the radiator 10 away from the top edge 321, and the second free end D2″ of the resonant structure 30 provided on the side where the second side edge 324 faces the same direction as the first free end D1 of the radiator 10. In this way, when the electronic device 1000 is folded, the third resonant structure 33 serves as the first resonant structure 31 on the side of the radiator 10 away from the top edge 321, and the electronic device 1000 can have improved upward radiation component of satellite communication and increased upper hemisphere radiation ratio in both the unfolded state and the folded state.

In some implementations, the resonant structure 30 is a part of the frame 320, or the resonant structure 30 is a part of the reference ground plate 500. For example, the resonant structure 30 is a branch extending from the edge of the reference ground plate 500, or a hollow structure is formed on the reference ground plate 500 to form the resonant structure 30.

The specific structure of the resonant structure 30 is not limited in the disclosure. For example, the resonant structure 30 is L-shaped. In some other embodiments, the resonant structure 30 may also be T-shaped, and in this case, the second resonant mode is a half-wavelength mode at the center frequency of the second frequency band.

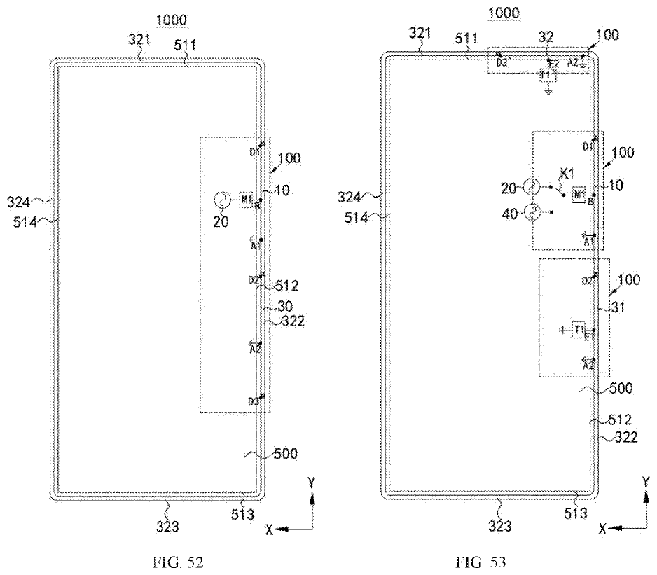

Specifically, referring to FIG. 52, the resonant structure 30 further includes a third free end D3. The third free end D3 and the second free end D2 are opposite ends of the resonant structure 30. The electrical length between the third free end D3 and the second free end D2 is close to half a wavelength at the center frequency of the second frequency band, so that the resonant structure 30 operates in a half-wavelength mode at the center frequency of the second frequency band under the excitation of the ground plate current.

In some implementations, the distance between the first free end D1 of the radiator 10 and the top edge 321 is 20 mm to 60 mm. By setting the distance between the first free end D1 of the radiator 10 and the top edge 321 to be 20 mm to 60 mm, the radiator 10 is as far away from the human head as possible when the electronic device 1000 is in the human head-hand call state, thereby reducing the influence of head loading on the efficiency of the antenna assembly 100 and lowering the SAR risk. Further, by setting the first free end D1 of the radiator 10 to be relatively far away from the bottom edge 323, the radiator 10 is located on the upper half of the first side edge 322, so as to avoid the problem such as signal blockage that would otherwise be caused when the first free end D1 arranged close to the bottom edge 323 is held by the hand in the hand-held state of the electronic device 1000.

The foregoing are examples of the radiator 10 operating in the satellite communication frequency band. The radiator 10 can also operate in the mobile communication frequency band.

Referring to FIG. 53, the antenna assembly 100 further includes at least one second signal source 40 and a first switch unit K1. The second signal source 40 is configured to provide a mobile communication excitation signal. The mobile communication excitation signal includes, but is not limited to, an LB frequency band excitation signal, an MHB frequency band excitation signal, a UHB frequency band excitation signal, a Wi-Fi frequency band excitation signal, etc. The disclosure takes the second signal source 40 providing an MHB frequency band excitation signal as an example. When the first frequency band and the second frequency band are Tiantong satellite frequency bands, the electrical length of the radiator 10 is close to the electrical length corresponding to the MHB frequency band, so that the radiator 10 is multiplexed as a Tiantong satellite antenna or an MHB antenna.

The first terminal of the first switch unit K1 is electrically connected with the first feed point B1, and further electrically connected with the first feed point B1 through the matching circuit M1. One selection terminal of the first switch unit K1 is electrically connected to the first signal source 20. The other selection terminal of the first switch unit K1 is electrically connected to at least one second signal source 40.

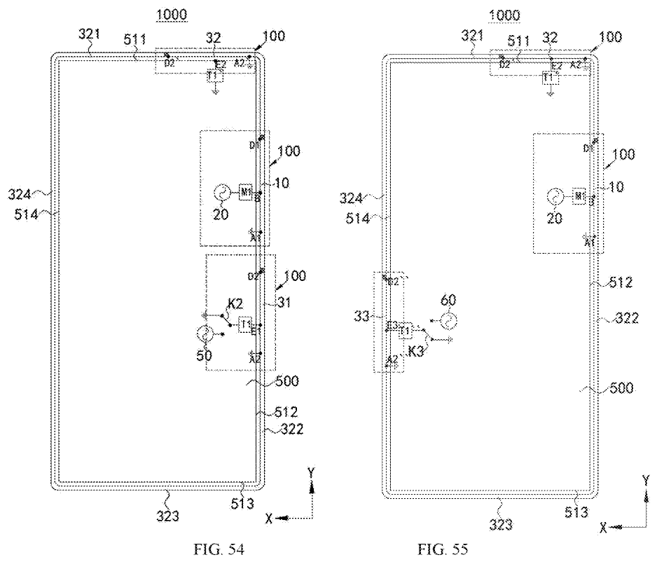

Further, referring to FIG. 54, the antenna assembly 100 further includes a third signal source 50 and a second switch unit K2. The third signal source 50 is configured to provide a mobile communication excitation signal. The fixed terminal of the second switch unit K2 is electrically connected with the first connection point E1 of the first resonant structure 31, and the selection terminal of the second switch unit K2 may be selectively electrically connected to the third signal source 50. When the radiator 10 operates in the satellite communication frequency band, the second switch unit K2 is turned off. When the radiator 10 operates in the mobile communication frequency band, the second switch unit K2 may be turned on or off.

In some implementations, referring to FIG. 55, the antenna assembly 100 further includes a fourth signal source 60 and a third switch unit K3. The fourth signal source 60 is configured to provide a mobile communication excitation signal. The fixed terminal of the third switch unit K3 is electrically connected to the third connection point E3 of the third resonant structure 33, and the selection terminal of the third switch unit K3 may be selectively electrically connected to the fourth signal source 60. When the radiator 10 operates in the satellite communication frequency band, the third switch unit K3 is turned off. When the radiator 10 operates in the mobile communication frequency band, the third switch unit K3 may be turned on or off.

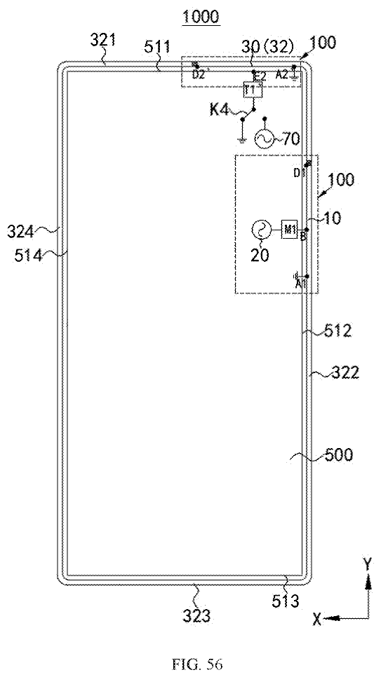

In some implementations, referring to FIG. 56, the antenna assembly 100 further includes a fifth signal source 70 and a fourth switch unit K4. The fifth signal source 70 is configured to provide a satellite communication excitation signal. The fixed terminal of the fourth switch unit K4 is electrically connected to the second connection point E2 of the second resonant structure 32, and the selection terminal of the fourth switch unit K4 may be selectively electrically connected to the fifth signal source 70. In this way, the second resonant structure 32 may be used as an auxiliary resonant structure 30 when the radiator 10 operates at the satellite frequency band, and of course, it may also be used as a top satellite antenna. The top satellite antenna and the side satellite antenna may be switched according to the strength of the satellite signal.

The antenna assembly 100 provided by the embodiments of the disclosure can improve the upper hemisphere energy ratio and the upper hemisphere left-hand circular polarization gain of the mobile phone. Since the main radiation antenna is located on the long side of the mobile phone, the SAR backoff in the head-hand call mode is reduced.

Although the embodiments of the disclosure have been illustrated and described above, it can be understood that the above embodiments are exemplary and should not be construed as limiting the disclosure, and those of ordinary skill in the art can make changes, modifications, substitutions and variations to the above embodiments within the scope of the disclosure, and these improvements and modifications also fall within the protection scope of the disclosure.

What is claimed is:

1. An electronic device, comprising:
a reference ground plate comprising a first ground plate edge, a second ground plate edge, a third ground plate edge and a fourth ground plate edge connected in sequence;
a frame surrounding a periphery of the reference ground plate, wherein the frame comprises a top edge, a first side edge, a bottom edge and a second side edge which are connected, the top edge is opposite to and spaced apart from the first ground plate edge, the first side edge is opposite to and spaced apart from the second ground plate edge, the bottom edge is opposite to and spaced apart from the third ground plate edge, and the second side edge is opposite to and spaced apart from the fourth ground plate edge; and
an antenna assembly comprising:
a radiator provided on the first side edge, wherein the radiator comprises a first ground terminal, a feed point and a first free end arranged in sequence, and the first ground terminal is electrically connected to the reference ground plate;
a signal source electrically connected with the feed point; and
at least one resonant structure provided on at least one of a side where the top edge is located, a side where the first side edge is located, and a side where the second side edge is located, wherein each of the at least one resonant structure comprises a second ground terminal and a second free end, the second ground terminal is electrically connected to the reference ground plate, and a direction from the first ground terminal to the first free end is the same as or does not intersect with a direction from the second ground terminal to the second free end;
wherein the signal source is configured to excite the radiator to operate in a first resonant mode supporting a first frequency band, and excite the reference ground plate to generate a ground plate current, the at least one resonant structure is configured to operate in a second resonant mode supporting a second frequency band at least under excitation of the ground plate current, and a center frequency of the first frequency band is greater than or equal to a center frequency of the second frequency band.

2. The electronic device as claimed in claim 1, wherein a principal radiation pattern of the antenna assembly in the first resonant mode and the second resonant mode points to the side where the top edge is located.

3. The electronic device as claimed in claim 1, wherein the at least one resonant structure comprises a first resonant structure, the first resonant structure is provided on the side where the first side edge is located, and a direction from the second ground terminal to the second free end of the first resonant structure is the same as a direction from the first ground terminal to the first free end of the radiator.

4. The electronic device as claimed in claim 3, wherein the first resonant structure is located on a side of the radiator away from the top edge.

5. The electronic device as claimed in claim 4, wherein a phase of a first resonant current of the radiator in the first resonant mode lags behind a phase of a second resonant current of the first resonant structure in the second resonant mode.

6. The electronic device as claimed in claim 1, wherein the antenna assembly further comprises a matching circuit electrically connected between the feed point and the signal source; and/or
the antenna assembly further comprises a tuning circuit, one terminal of the tuning circuit is electrically connected between the second ground terminal and the second free end, another terminal of the tuning circuit is grounded, and the tuning circuit is configured to tune a resonance frequency of the resonant structure.

7. The electronic device as claimed in claim 6, wherein the matching circuit comprises a first inductor and a first capacitor, the first inductor is electrically connected between the feed point and the signal source, one terminal of the first capacitor is electrically connected between the first inductor and the signal source, and another terminal of the first capacitor is grounded.

8. The electronic device as claimed in claim 6, wherein the tuning circuit comprises a second capacitor and a second inductor, one terminal of the second capacitor is electrically connected between the second ground terminal and the second free end, another terminal of the second capacitor is grounded, one terminal of the second inductor is electrically connected to the one terminal of the second capacitor, and another terminal of the second inductor is grounded.

9. The electronic device as claimed in claim 1, wherein the at least one resonant structure comprises a second resonant structure, the second resonant structure is provided on the side where the top edge is located, the second free end of the second resonant structure faces the side where the second side edge is located, the first free end of the radiator faces the side where the top edge is located, and the second resonant structure is configured to guide the ground plate current to be distributed in an area close to the first ground plate edge.

10. The electronic device as claimed in claim 9, wherein a distance between the second resonant structure and the first side edge is smaller than a distance between the second resonant structure and the second side edge.

11. The electronic device as claimed in claim 9, wherein the ground plate current comprises a first sub-current and a second sub-current, the first sub-current is distributed between the first ground terminal and the first ground plate edge, the second sub-current is distributed between the first ground terminal and the third ground plate edge, and a current intensity of the first sub-current is greater than a current intensity of the second sub-current.

12. The electronic device as claimed in claim 3, wherein the at least one resonant structure further comprises a second resonant structure, the second resonant structure is provided on the side where the top edge is located, the second free end of the second resonant structure faces the side where the second side edge is located, the first free end of the radiator faces the side where the top edge is located, and the second resonant structure is configured to guide the ground plate current to be distributed in an area close to the first ground plate edge.

13. The electronic device as claimed in claim 1, wherein the at least one resonant structure comprises a third resonant structure, the third resonant structure is provided on the side where the second side edge is located, and the third resonant structure is configured to increase a transverse current on the reference ground plate, a direction of the transverse current being along the first ground plate edge.

14. The electronic device as claimed in claim 13, wherein a direction from the second ground terminal to the second free end of the third resonant structure is the same as the direction from the first ground terminal to the first free end of the radiator.

15. The electronic device as claimed in claim 12, wherein the at least one resonant structure further comprises a third resonant structure, the third resonant structure is provided on the side where the second side edge is located, and the third resonant structure is configured to increase a transverse current on the reference ground plate, a direction of the transverse current being along the first ground plate edge.

16. The electronic device as claimed in claim 1, wherein the reference ground plate comprises a first ground plate, a rotating shaft and a second ground plate connected in sequence, and the at least one resonant structure and the radiator are both located on a same side of the rotating shaft.

17. The electronic device as claimed in claim 15, wherein the reference ground plate comprises a first ground plate, a rotating shaft and a second ground plate connected in sequence, the second resonant structure provided on the side where the top edge is located and the radiator are located on a same side of the rotating shaft, and the third resonant structure provided on the side where the second side edge is located and the radiator are located on opposite sides of the rotating shaft respectively.

18. The electronic device as claimed in claim 17, wherein when the first ground plate and the second ground plate are in a folded state, the third resonant structure provided on the side where the second side edge is located is located on a side of the radiator away from the top edge, and the second free end of the third resonant structure provided on the side where the second side edge is located faces a same direction as the first free end of the radiator.

19. The electronic device as claimed in claim 1, wherein the at least one resonant structure is a part of the frame, or the at least one resonant structure is a part of the reference ground plate.

20. The electronic device as claimed in claim 1, wherein the resonant structure further comprises a third free end, and the third free end and the second free end are opposite ends of the resonant structure; and
wherein a distance between the first free end of the radiator and the top edge is 20 mm-60 mm.
